(19) United States
(12) Patent Application Publication
(10) Pub. No.: US 2025/0197661 A1
(43) Pub. Date: Jun. 19, 2025

(54) INKJET INK FORMULATIONS

(71) Applicant: LANDA CORPORATION LTD., Rehovot (IL)

(72) Inventors: Efrat OHAYON NAOR, Ashdod (IL); Helena CHECHIK, Rehovot (IL); Yelena YUSUPOV, Holon (IL)

(21) Appl. No.: 18/851,727

(22) PCT Filed: Apr. 13, 2023
(86) PCT No.: PCT/IL2023/050390

§ 371 Date: Sep. 27, 2024

Related U.S. Application Data
(60) Provisional application No. 63/362,971, filed on Apr. 14, 2022.

(51) Int. Cl. C09D 11/38; B41J 2/005; B41J 2/01; B41J 11/00; B41M 5/025; B41M 7/00; C09D 11/102; C09D 11/12

(52) U.S. Cl. CPC C09D 11/38; B41J 2/0057; B41J 11/0022; B41M 5/0256; B41M 7/009; C09D 11/102; C09D 11/12; B41J 2002/012

(57) ABSTRACT

The present disclosure relates to inkjet ink formulations and their use in improving the printing process and/or the resulted printed product. The present disclosure further relates to printing methods utilizing the inkjet ink formulations and to printing systems comprising thereof.

### TECHNOLOGICAL FIELD

The present disclosure relates to inkjet ink formulations and their use in improving the printing process and the resulted printed product.

### BACKGROUND ART

The present invention relates to ink formulations suitable for ink jet printing systems, and more particularly for indirect printing systems in which an inkjet print head is used to print an image onto the surface of an intermediate transfer member (ITM) which is then used to transfer the image onto a substrate.

While indirect printing technique overcomes many problems associated with inkjet printing directly onto the substrate, there remains a need for improvement of this technique, in particular, improvement in ink formulations suitable for ink jetting on the intermediate transfer member of an indirect printing system. Quality printed articles are also desired.

The following patent applications/publications to the Applicant provide potentially relevant background material, and are all incorporated herein by reference in their entirety:
[1] WO 2013/132439 (PCT/IB2013/51755);
[2] WO 2015/036865 (PCT/IB2014/02395);
[3] WO 2017/208152 (PCT/IB2017/053177);
[4] WO 2013/132418 (PCT/IB2013/051716);
[5] WO 2019/012456 (PCT/IB2018/055126);
[6] WO 2020/003088 (PCT/IB2019/055288);
[7] WO 2013/132420 (PCT/IB2013/051718);
[8] WO 2015/036906 (PCT/IB2014/064277);
[9] WO 2020/136517 (PCT/IB2019/061081);
[10] WO 2020/141465 (PCT/IB2020/050001);
[11] WO 2022/024106 (PCT/IL2021/050846); and
[12] PCT/IL2023/050117.

Acknowledgement of the above references herein is not to be inferred as meaning that these are in any way relevant to the patentability of the presently disclosed subject matter.

### SUMMARY OF THE INVENTION

The inventors of the present invention have developed water-based inkjet ink formulations/compositions which comprise at least one surfactant selected to provide the ink formulations with dynamic surface tension characteristics which beneficially affect the printing process and the quality of the resulted printed image.

As will be demonstrated herein below, the inventors of the present invention have surprisingly found that ink-jet ink formulations having a dynamic surface tension of between about 37 to about 50 mN/m (measured at a bubble life-time of 0.015 sec) and a static surface tension of between about 23.0 to about 25.5 mN/m (measured at a bubble life-time of 10 sec), advantageously affected the printing process and the printed image quality and resolution.

The above noted dynamic surface tension and static surface tension were both determined at room temperature (e.g., about 22° C.) with the bubble pressure method, utilizing the Sita bubble pressure tensiometer—Model Sita online (Pro-line T15).

The ink-jet ink formulations/compositions of the present invention are inter-alia utilized in indirect printing processes. Such printing processes have been detailed e.g., in the patent publications/applications to the Applicant [1]-[12]. Briefly, in such processes an aqueous ink formulation is first jetted on an intermediate transfer member to form an ink image thereon. The formed ink-image is subsequently transferred from the ITM to the final substrate. The ITM is hydrophobic in nature (e.g., made from silicone). For good performance, efficient wetting of the ITM by the ink formulation is of interest. This is usually achieved by ink formulations with relatively low surface tension e.g., being of below 25 mN/m at room temperature. The inventors of the present invention have found that while utilizing such ink formulations is optimal for ITM wetting, improvement is still needed for better printing performance and printing quality. For example, the inventors have identified sweating effect of the ink on the nozzle plate of the print head (PH) i.e., ink spreading over the nozzle plate of the PH, during printing, during PHs automatic cleaning and also at non-printing (stand by) periods. This sweating effect was mitigated when the ink formulations of the present invention were utilized in the printing process. Mitigation of the ink sweating on the PHs was achieved by adjusting the dynamic surface tension of the ink formulations, enabling high surface tension at high frequency areas, and reaching standard low surface tension at low frequency areas. The adjustment of the dynamic surface tension was achieved by utilizing specific surfactant/s that provided an optimal dynamic surface tension profile.

Without wishing to be bound by theory, it is believed that surfactants applicable to the present invention have low diffusion coefficients i.e., they can move relatively slow from high concentration area to low concentration area. Due to this effect, dynamic surface tension is relatively high at high frequency of bubble formation. Further without wishing to be bound by theory, the inventors of the present disclosure have developed inkjet ink formulations with relatively high dynamic surface tension taking the advantage of the fact that the spreading timescales of the ink on the printed substrate (e.g., in a direct printing process) or ITM (in an indirect printing process) are much shorter than on the print head. Thus, these ink formulations achieve spreading properties on the substrate or ITM similar to those of inks with low surface tension, while preventing the down sides of undesired sweating of the print head nozzle plates.

The ink formulations of the present invention not only advantageously illustrated substantially no sweating effects on the PH when utilized in the printing process, they also provided the printing process with one or more of improved jetting stability over a long period of time; more available printing cycles/runs (inter-alia due to reduced accumulations of the ink in the ink nozzle); improved print heads life span: ease of maintenance; improved process stability; and improved printing quality (e.g., one or more of improvement in the uniformity of printing, ink wetting on the ITM, dot size, ink spreading characteristics, missing nozzles compensation and print head compatibility).

Thus, the present invention provides in one of its aspects a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (RT, e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension.

In a further one of its aspects the present invention provides a method for preventing and/or minimizing and/or mitigating inkjet ink sweating on the print head of a printing system (e.g., the print head being used in an inkjet printing process and forms part of a printing system), wherein said method comprises utilizing (e.g., in the printing process) a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension, to thereby prevent and/or minimize and/or mitigate inkjet ink sweating on the print head of a printing system.

In another one of its aspects the present invention provides a method for preventing and/or minimizing and/or mitigating inkjet ink sweating on the print head of a printing system (e.g., the print head being used in an inkjet printing process and forms part of a printing system), wherein said method comprises utilizing the water-based inkjet ink formulation of the invention, as herein disclosed.

In a further one of its aspects the present invention provides a water-based inkjet ink formulation as herein disclosed, for use in a method for preventing and/or minimizing and/or mitigating inkjet ink sweating on the print head of a printing system.

Yet, in a further one of its aspects the present invention provides a water-based inkjet ink formulation as herein disclosed, for use in preventing and/or minimizing and/or mitigating inkjet ink sweating on the print head of a printing system.

In a further one of its aspects the present invention provides a method for one or more of improving a printing process and improving the quality of the resulted printed image, wherein said method comprises utilizing (e.g., in the printing process) a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension, to thereby improve one or more of the printing process and the quality of the resulted printed image.

In another one of its aspects the present invention provides a method for one or more of improving a printing process and improving the quality of the resulted printed image, the method comprising utilizing in the printing process the water-based inkjet ink formulation as herein disclosed.

In a further one of its aspects the present invention provides a water-based inkjet ink formulation as herein disclosed, for use in a method for one or more of improving a printing process and improving the quality of the resulted printed image.

Yet, in a further one of its aspects the present invention provides a water-based inkjet ink formulation as herein disclosed, for use in one or more of improving a printing process and improving the quality of the resulted printed image.

In another one of its aspects the present invention provides a water-based inkjet ink formulation as herein disclosed, for use in a printing process e.g., as herein described.

In a further one of its aspects the present invention provides a water-based inkjet ink formulation as herein disclosed, said formulation forming part of a printing system e.g., as herein described.

In yet a further one of its aspects the present invention provides a printing method utilizing the water-based inkjet ink formulation as herein disclosed.

Yet, in a further one of its aspects the present invention provides a method of printing on a substrate, the method comprises ink-jetting an ink formulation onto a printing substrate by utilizing one or more print bars, each of which comprises one or more print heads, to thereby form ink images on said substrate, wherein the ink formulation is the water-based inkjet ink formulation according to the invention.

In another one of its aspects the present invention provides a printing method comprising:
providing an intermediate transfer member comprising a release layer surface;
ink-jetting an ink formulation onto said release layer surface by utilizing one or more print bars, each of which comprises one or more print heads, to thereby form ink images on said release layer surface; and
transferring said ink images from the intermediate transfer member to a printing substrate;
wherein said ink formulation is the water-based inkjet ink formulation according to the invention.

Yet, in a further one of its aspects the present invention provides a printing system comprising the water-based inkjet ink formulation as herein disclosed.

In another one of its aspects the present invention provides a printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation according to the present invention.

In a further one of its aspects the present invention provides a printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation according to the present invention; and
a transfer station for transferring the ink images from the intermediate transfer member to a printing substrate.

In yet a further one of its aspects the present invention provides a printing system and a printing process substantially as herein described.

Yet in a further one of its aspects the present invention provides water-based inkjet ink formulations substantially as herein described.

In another one of its aspects the present invention provides water-based inkjet ink formulations with dynamic surface tension and static surface tension as herein exemplified and illustrated e.g., in the figures.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic side view of a printing system (e.g., digital printing system), according to some embodiments of the invention.

FIGS. 2A-2B display the dynamic surface tension profile (time scale) of some ink formulations not according to the invention and an ink formulation according to some embodiments of the invention.

FIG. 3 display the dynamic surface tension profile (log scale) of some ink formulations not according to the invention and an ink formulation according to some embodiments of the invention.

FIGS. 4A-4D display images of nozzle plates (upper panel) and the resulted printed substrate (lower panel) when used with some ink formulations not according to the invention and an ink formulation according to some embodiments of the invention.

FIGS. 5A-5B display ink contact angle (CA) measurements on hydrophobic ITM coated with a treatment formulation, at 80° C. The display is of some ink formulations not according to the invention and an ink formulation according to some embodiments of the invention.

FIGS. 6A-6B display the dynamic surface tension profile (time scale) of an ink formulation not according to the invention and ink formulations according to some embodiments of the invention.

FIG. 7 display the dynamic surface tension profile (log scale) of an ink formulation not according to the invention and ink formulations according to some embodiments of the invention.

FIG. 8 display the dynamic surface tension profile (time scale) of ink formulations according to some embodiments of the invention.

FIG. 9 display the dynamic surface tension profile (log scale) of ink formulations according to some embodiments of the invention.

### DETAILED DESCRIPTION OF THE INVENTION

The present invention provides in one of its aspects a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension.

Various embodiments will be detailed herein in connection with the aforementioned aspect of the invention. It is noted that one or more embodiments which are detailed in connection with the water-based inkjet ink formulation of the invention may also be applicable mutatis mutandis to other aspects of the invention e.g., methods, processes, uses and systems.

It is further noted that various means to measure dynamic surface tension and static surface tension are known to a person versed in the art. Thus, the present disclosure is not to be considered as limited to the specific Sita bubble pressure tensiometer, and other corresponding measurements are equivalent and are withing the scope of the present invention. It is noted that a person versed in the art is familiar with other measuring means and the conversion between the above specified dynamic surface tension and static surface tension to equivalent values thereof measured by other means.

At times, the ink formulations of the present invention may be referred to as “high dynamic surface tension ink formulations” having a dynamic surface tension of about about 37 to about 50 mN/m e.g., measured at room temperature by Model Sita online (Pro-line T15). The ink formulations of the present invention have a dynamic surface tension which is higher than the static surface tension thereof, measured at the same temperature.

In some embodiments of the invention the dynamic surface tension of the ink formulations is between about 37 to about 50 mN/m, inclusive (measured at a bubble lifetime of about 0.015 sec, RT). Any value within the above range is within the scope of the present invention e.g., 37.0, 37.1, 37.2, 37.3, 37.4, 37.5, 37.6, 37.7, 37.8, 37.9, 38.0, 38.1, 38.2, 38.3, 38.4, 38.5, 38.6, 38.7, 38.8, 38.9, 39.0, 39.1, 39.2, 39.3, 39.4, 39.5, 39.6, 39.7, 39.8, 39.9, 40.0, 40.1, 40.2, 40.3, 40.4, 40.5, 40.6, 40.7, 40.8, 40.9, 41.0, 41.1, 41.2, 41.3, 41.4, 41.5, 41.6, 41.7, 41.8, 41.9, 42.0, 42.1, 42.2, 42.3, 42.4, 42.5, 42.6, 42.7, 42.8, 42.9, 43.0, 43.1, 43.2, 43.3, 43.4, 43.5, 43.6, 43.7, 43.8, 43.9, 44.0, 44.1, 44.2, 44.3, 44.4, 44.5, 44.6, 44.7, 44.8, 44.9, 45.0, 45.1, 45.2, 45.3, 45.4, 45.5, 45.6, 45.7, 45.8, 45.9, 46.0, 46.1, 46.2, 46.3, 46.4, 46.5, 46.6, 46.7, 46.8, 46.9, 47.0, 47.1, 47.2, 47.3, 47.4, 47.5, 47.6, 47.7, 47.8, 47.9, 48.0, 48.1, 48.2, 48.3, 48.4, 48.5, 48.6, 48.7, 48.8, 48.9, 49.0, 49.1, 49.2, 49.3, 49.4, 49.5, 49.6, 49.7, 49.8, 49.9 and 50.0 mN/m.

In some embodiments of the invention the static surface tension of the ink formulations is between about 23.0 to about 25.5 mN/m, inclusive (measured at a bubble lifetime of about 10 sec, RT). Any value within the above range is within the scope of the present invention e.g., 23.0, 23.1, 23.2, 23.3, 23.4, 23.5, 23.6, 23.7, 23.8, 23.9, 24.0, 24.1, 24.2, 24.3, 24.4, 24.5, 24.6, 24.7, 24.8, 24.9, 25.0, 25.1, 25.2, 25.3, 25.4, and 25.5 mN/m.

In some embodiments of the invention the static surface tension of the ink formulations is between about 23.0 to about 25.5 mN/m, inclusive (measured with the standard liquid tensiometer, Kruss force tensiometer (K20 model), at a frequency of 5 Hz, at RT). Any value within the above range is within the scope of the present invention e.g., 23.0, 23.1, 23.2, 23.3, 23.4, 23.5, 23.6, 23.7, 23.8, 23.9, 24.0, 24.1, 24.2, 24.3, 24.4, 24.5, 24.6, 24.7, 24.8, 24.9, 25.0, 25.1, 25.2, 25.3, 25.4, and 25.5 mN/m.

In some embodiments of the invention the static surface tension of the ink formulations is between about 23.6 to about 24.7 mN/m, inclusive (measured at a bubble lifetime of about 10 sec, RT).

In some embodiments of the invention the static surface tension of the ink formulations is further determined with the standard liquid tensiometer, Kruss force tensiometer (K20 model), at a frequency of 5 Hz, at RT.

In some embodiments of the invention the static surface tension of the ink formulations is between about 23.8 to about 24.5 mN/m, inclusive (measured with the standard liquid tensiometer, Kruss force tensiometer (K20 model), at a frequency of 5 Hz, at RT).

In some embodiments of the invention the dynamic surface tension of the ink formulations is as herein exemplified.

In some embodiments of the invention the static surface tension of the ink formulations is as herein exemplified.

In some embodiments, the surfactant is a non-ionic surfactant.

In some embodiments, the surfactant is an anionic surfactant.

In some embodiments of the invention the at least one surfactant is a surfactant of a first type and/or a surfactant of a second type.

In some embodiments of the invention the ink formulation of the present invention comprises at least one surfactant of a first type and/or at least one surfactant of a second type.

In some embodiments of the invention the at least one surfactant is a surfactant of a first type.

In some embodiments of the invention the surfactant of a first type is a silicone surfactant.

In some embodiments of the invention the silicone surfactant may be siloxane or siloxane copolymer e.g., polyether siloxane copolymers.

In some embodiments of the invention the silicone surfactant may be a polyether-modified siloxane surfactant. To this end, the term modified is envisaged as a siloxane in which the silicone basic structure is chemically modified by adding one or more polyether side chains (e.g., polyethylene glycol, PEG). In some embodiments the polyether may consist of ethylene oxide (EO) units, propylene oxide (PO) units or any combination thereof. In some embodiments the polyether may consist of ethylene oxide units. In some embodiments the polyether may consist of propylene oxide units. In some embodiments the polyether may consist of ethylene oxide units and propylene oxide units.

In some embodiments of the invention the silicone surfactant may be a polyether-modified polydimethylsiloxane surfactant. To this end, the term modified is envisaged as a siloxane in which the silicone basic structure is chemically modified by adding one or more polyether side chains (e.g., polyethylene glycol, PEG). In some embodiments the polyether may consist of ethylene oxide (EO) units, propylene oxide (PO) units or any combination thereof. In some embodiments the polyether may consist of ethylene oxide units. In some embodiments the polyether may consist of propylene oxide units. In some embodiments the polyether may consist of ethylene oxide units and propylene oxide units.

In some embodiments of the invention the silicone surfactant is selected from the group consisting of Tego 4100, Byk 349, BYK 348, BYK-3456, BYK-3455 and any combination thereof.

In some embodiments of the invention the silicone surfactant is selected from the group consisting of Byk 349, BYK 348, BYK-3455 and BYK-3456 and any combination thereof.

In some embodiments of the invention the silicone surfactant is a siloxane-based gemini surfactant e.g., Tego 4100 (CAS No. 134180-76-0, containing Oxirane, 2-methyl-, polymer with oxirane, mono [3-[1,3,3,3-tetramethyl-1-[(trimethylsilyl)oxy]-1-disiloxanyl]propyl]ether).

In some embodiments of the invention the silicone surfactant is a polyether-modified siloxane selected from the group consisting of Byk 349, BYK 348, BYK-3455 and any combination thereof.

In some embodiments of the invention the silicone surfactant is a polyether-modified siloxane selected from the group consisting of Byk 349, BYK 348 and BYK-3455.

In some embodiments of the invention the silicone surfactant is a polyether-modified polydimethylsiloxane e.g., BYK-3456.

In some embodiments of the invention the silicone surfactant is Byk 349 (polyether-modified siloxane).

In some embodiments of the invention the silicone surfactant is BYK 348 (polyether-modified siloxane).

In some embodiments of the invention the silicone surfactant is BYK-3455 (polyether-modified siloxane).

In some embodiments of the invention the silicone surfactant is BYK-3456 (polyether-modified polydimethylsiloxane).

In some embodiments the polyether-modified polydimethylsiloxane, e.g., BYK-3456 silicone surfactant, may be active at the interface to the substrate and the surface at the same time i.e., it has swimming depth, being able to swim in various depths, against air (and as such affecting levelling), or deeper (and as such affecting wetting).

Without wishing to be bound be theory, the selection of the surfactant of the invention i.e., the at least one surfactant that provides the ink compositions of the invention with their specific dynamic and static surface tension properties, may be determined by one or more of the surfactant chemical nature and molecular weight. Applicable surfactants are those that come out to the surface of the ink drop slowly so as to provide the ink with its unique dynamic surface tension characteristics.

In some embodiments the at least one surfactant is of a molecular weight being sufficiently heavy to thereby provide the ink compositions of the invention with their specific dynamic and static surface tension properties.

In some embodiments the at least one surfactant is of a chemical structure that is comprised of multiple repeating units e.g., monomeric units, wherein the number of the repeating units is sufficiently high to thereby provide the ink compositions of the invention with their specific dynamic and static surface tension properties.

In some embodiments the at least one surfactant is of a chemical structure that is comprised of multiple repeating units e.g., monomeric units, that may be modified e.g., chemically modified, by one or more side chains, wherein the number of the modified repeating units is sufficiently high to thereby provide the ink compositions of the invention with their specific dynamic and static surface tension properties.

In some embodiments the at least one silicone surfactant is comprised of multiple repeating units (e.g., siloxane units), wherein the number of the repeating units is sufficiently high to thereby provide the ink compositions of the invention with their specific dynamic and static surface tension properties.

In some embodiments the at least one silicone surfactant is of a chemical structure that is comprised of multiple repeating units e.g., siloxane units, that may be modified e.g., by one or more polyether side chains (e.g., polyethylene glycol, PEG), wherein the number of the modified repeating units is sufficiently high to thereby provide the ink compositions of the invention with their specific dynamic and static surface tension properties.

In some embodiments the at least one surfactant is of a chemical structure that is comprised of multiple repeating units that may be modified by one or more side chains (e.g., polyether side chains such as PEG) wherein a ratio of the number of the non-modified repeating units to the number of the modified repeating units is selected to provide the ink compositions of the invention with their specific dynamic and static surface tension properties.

In some embodiments the at least one silicone surfactant is of a chemical structure that is comprised of multiple repeating units that may be modified by one or more side chains (e.g., polyether side chains such as PEG) wherein a ratio of the number of the non-modified repeating units to the number of the modified repeating units is selected to provide the ink compositions of the invention with their specific dynamic and static surface tension properties.

In some embodiments the at least one silicone surfactant is of a chemical structure that is comprised of multiple repeating siloxane units that may be modified by one or more side chains e.g., polyether side chains (such as polyethylene glycol, PEG), wherein a ratio of the number of the non-modified repeating siloxane units to the number of the modified repeating siloxane units is selected to provide the ink compositions of the invention with their specific dynamic and static surface tension properties.

In some embodiments of the invention the silicone surfactant is a polyether-modified siloxane having a multiple number of repeating units, to thereby provide the ink compositions of the invention with their specific dynamic and static surface tension properties.

In some embodiments of the invention the silicone surfactant is a polyether-modified siloxane having a multiple number of modified repeating units, to thereby provide the ink compositions of the invention with their specific dynamic and static surface tension properties.

In some embodiments of the invention the silicone surfactant is a polyether-modified siloxane having a multiple number of modified repeating units (e.g., modified with polyether side chains such as polyethylene glycol, PEG), wherein a ratio of the number of the non-modified siloxane units to the number of the modified repeating units (e.g., siloxane units modified with PEG) is selected to provide the ink compositions of the invention with their specific dynamic and static surface tension properties.

In some embodiments of the invention the silicone surfactant is a polyether-modified polydimethylsiloxane having a multiple number of repeating units, to thereby provide the ink compositions of the invention with their specific dynamic and static surface tension properties.

In some embodiments of the invention the silicone surfactant is a polyether-modified polydimethylsiloxane having a multiple number of modified repeating units, to thereby provide the ink compositions of the invention with their specific dynamic and static surface tension properties.

In some embodiments of the invention the silicone surfactant is a polyether-modified polydimethylsiloxane having a multiple number of modified repeating units (e.g., modified with polyether side chains such as polyethylene glycol, PEG), wherein a ratio of the number of the non-modified siloxane units to the number of the modified repeating units (e.g., siloxane units modified with PEG) is selected to provide the ink compositions of the invention with their specific dynamic and static surface tension properties.

In some embodiments the at least one surfactant is of a chemical structure that is comprised of at least about 4, 5, 6, 7, 8, 9, 10, 11, 12, 13, 14, 15, 16, 17, 18, 19, or about 20 repeating units.

In some embodiments the at least one surfactant is of a chemical structure that is comprised of at least about 4, 5, 6, 7, 8, 9, 10, 11, 12, 13, 14, 15, 16, 17, 18, 19, or about 20 chemically modified repeating units (e.g., modified with polyether side chains such as polyethylene glycol, PEG).

In some embodiments the at least one surfactant is a polyether-modified siloxane having at least about 4 repeating units.

In some embodiments the at least one surfactant is a polyether-modified siloxane having at least about 4 modified repeating units.

In some embodiments the at least one surfactant is a polyether-modified siloxane having at least about 4 polyether-modified repeating units.

In some embodiments the at least one surfactant is a polyether-modified siloxane having between about 4 to about 20 repeating units, inclusive.

In some embodiments the at least one surfactant is a polyether-modified siloxane having at least about 20 repeating units.

In some embodiments the at least one surfactant is a polyether-modified siloxane having between about 4 to about 20 modified repeating units, inclusive.

In some embodiments the at least one surfactant is a polyether-modified siloxane having at least about 20 modified repeating units.

In some embodiments the at least one surfactant is a polyether-modified polydimethylsiloxane having at least about 4 repeating units.

In some embodiments the at least one surfactant is a polyether-modified polydimethylsiloxane having at least about 4 modified repeating units.

In some embodiments the at least one surfactant is a polyether-modified polydimethylsiloxane having at least about 4 polyether-modified repeating units.

In some embodiments the at least one surfactant is a polyether-modified polydimethylsiloxane having between about 4 to about 20 repeating units, inclusive.

In some embodiments the at least one surfactant is a polyether-modified polydimethylsiloxane having at least about 20 repeating units.

In some embodiments the at least one surfactant is a polyether-modified polydimethylsiloxane having between about 4 to about 20 modified repeating units, inclusive.

In some embodiments the at least one surfactant is a polyether-modified polydimethylsiloxane having at least about 20 modified repeating units.

In some embodiments the at least one surfactant is a polyether-modified siloxane having at least about 4, 5, 6, 7, 8, 9, 10, 11, 12, 13, 14, 15, 16, 17, 18, 19, or about 20 repeating units.

In some embodiments the at least one surfactant is a polyether-modified siloxane having at least about 4, 5, 6, 7, 8, 9, 10, 11, 12, 13, 14, 15, 16, 17, 18, 19, or about 20 chemically modified repeating units (e.g., modified with polyether side chains such as polyethylene glycol, PEG).

In some embodiments the at least one surfactant is a polyether-modified polydimethylsiloxane having at least about 4, 5, 6, 7, 8, 9, 10, 11, 12, 13, 14, 15, 16, 17, 18, 19, or about 20 repeating units.

In some embodiments the at least one surfactant is a polyether-modified polydimethylsiloxane having at least about 4, 5, 6, 7, 8, 9, 10, 11, 12, 13, 14, 15, 16, 17, 18, 19, or about 20 chemically modified repeating units (e.g., modified with polyether side chains such as polyethylene glycol, PEG).

In some embodiments of the invention the silicone surfactant is not one or more of Tego 240, Tego 280 and Tego 270. Without wishing to be bound by theory, the inventors believe that the number of the siloxane repeating units (modified or not) in these surfactants, which affects the molecular weight of these surfactants, is insufficient to provide these surfactants with the ability to afford the ink compositions of the invention with their specific dynamic and static surface tension properties.

In some embodiments of the invention the silicone surfactant is not Tego 240 [Evonik, Polyether-modified trisiloxane, CAS No. 122-20-3 (2-propanol, 1,1′,1″-nitrilotris <0.05%) and CAS No. 614-100-2 (Poly(oxy-1,2-ethanediyl),a-[3-[1,3,3,3-tetramethyl-1-[(trimethylsilyl)oxy]disiloxanyl]propyl]-w-hydroxy, 75-85%)].

In some embodiments of the invention the silicone surfactant is not Tego 280 (CAS No. 68938-54-5, Evonik, Polyether-modified siloxane, comprising: Siloxanes and Silicones, di-Me, 3-hydroxypropyl Me, ethers with polyethylene glycol mono Me-ether, 75-100%).

In some embodiments of the invention the silicone surfactant is not Tego 270 (CAS No. 68938-54-5, Evonik, Polyether-modified siloxane, comprising: Siloxanes and Silicones, di-Me, 3-hydroxypropyl Me, ethers with polyethylene glycol mono Me-ether, 75-90%).

In some embodiments of the invention the silicone surfactant is one or more of at least one polyether-modified siloxane surfactant and at least one polyether-modified polydimethylsiloxane.

In some embodiments of the invention the silicone surfactant is one or more of at least one polyether-modified siloxane surfactant, at least one polyether-modified polydimethylsiloxane, and at least one siloxane-based gemini surfactant.

In some embodiments the siloxane-based gemini surfactant contains Oxirane, 2-methyl-, polymer with oxirane, mono [3-[1,3,3,3-tetramethyl-1-[(trimethylsilyl)oxy]-1-disiloxanyl]propyl]ether.

In some embodiments of the invention the silicone surfactant is selected from the group consisting of polyether-modified polydimethylsiloxane, polyether-modified siloxane, siloxane-based gemini surfactant and any combination thereof.

In some embodiments of the invention the at least one surfactant is a surfactant of a second type.

In some embodiments of the invention the surfactant of a second type is a non-silicone surfactant.

In some embodiments of the invention the non-silicone surfactant is a blend of ethoxylated acetylene diol and dioctyl sodium sulfosuccinate in solvent.

In some embodiments of the invention the non-silicone surfactant is Surfynol PSA 336 [Evonic, CAS No. 577-11-7 (Butanedioic acid, sulfo-1,4-bis(2-ethylhexyl) ester, sodium salt, 20-50%) and CAS No. 9014-85-1 (Ethoxylated 2,4,7,9-tetramethyl-5-decyn-4,7-diol, 20-50%) being a blend of ethoxylated acetylene diol and dioctyl sodium sulfosuccinate in solvent].

In some embodiments of the invention the at least one surfactant is a surfactant of a first type, being a silicone surfactant, wherein the formulation optionally further comprises at least one surfactant of a second type, being a non-silicone surfactant.

In some embodiments of the invention the at least one surfactant is a surfactant of a first type, being a silicone surfactant, wherein the formulation further comprises at least one surfactant of a second type, being a non-silicone surfactant.

In some embodiments of the invention the at least one surfactant is a surfactant of a second type, being a non-silicone surfactant, wherein the formulation optionally further comprises at least one surfactant of a first type, being a silicone surfactant.

In some embodiments of the invention the at least one surfactant is a surfactant of a second type, being a non-silicone surfactant, wherein the formulation further comprises at least one surfactant of a first type, being a silicone surfactant.

In some embodiments the ink formulation of the invention comprises at least one surfactant of a first type, being a silicone surfactant selected from the group consisting of polyether-modified polydimethylsiloxane, polyether-modified siloxane, siloxane-based gemini surfactant and any combination thereof, wherein the ink formulation optionally further comprises at least one surfactant of a second type being a blend of ethoxylated acetylene diol and dioctyl sodium sulfosuccinate in solvent.

In some embodiments the ink formulation of the invention comprises at least one surfactant of a second type being a blend of ethoxylated acetylene diol and dioctyl sodium sulfosuccinate in solvent, wherein the ink formulation optionally further comprises at least one surfactant of first type, being a silicone surfactant selected from the group consisting of polyether-modified polydimethylsiloxane, polyether-modified siloxane, siloxane-based gemini surfactant and any combination thereof.

In some embodiments the ink formulation of the invention comprises at least one surfactant of a first type, being one or more of at least one polyether-modified siloxane surfactant and at least one polyether-modified polydimethylsiloxane, and at least one surfactant of a second type, being a blend of ethoxylated acetylene diol and dioctyl sodium sulfosuccinate in solvent.

In some embodiments the ink formulation of the invention comprises at least one surfactant of a first type, being one or more of at least one polyether-modified siloxane surfactant, at least one polyether-modified polydimethylsiloxane, and at least one siloxane-based gemini surfactant, and at least one surfactant of a second type being a blend of ethoxylated acetylene diol and dioctyl sodium sulfosuccinate in solvent.

In some embodiments the ink formulation of the invention comprises at least one surfactant of a first type being at least one polyether-modified siloxane surfactant, and at least one surfactant of a second type being a blend of ethoxylated acetylene diol and dioctyl sodium sulfosuccinate in solvent.

In some embodiments the ink formulation of the invention comprises at least one surfactant of a first type, being at least one polyether-modified polydimethylsiloxane, and at least one surfactant of a second type being a blend of ethoxylated acetylene diol and dioctyl sodium sulfosuccinate in solvent.

In some embodiments the ink formulation of the invention comprises at least one surfactant of a first type, being at least one siloxane-based gemini surfactant, and at least one surfactant of a second type being a blend of ethoxylated acetylene diol and dioctyl sodium sulfosuccinate in solvent.

In some embodiments the ink formulation of the invention comprises at least one surfactant being a surfactant of a first type i.e., a silicone surfactant, selected from the group consisting of Tego 4100, Byk 349, BYK 348, BYK-3456, BYK-3455 and any combination thereof, wherein the ink formulation optionally further comprises at least one surfactant of a second type i.e., being a non-silicone surfactant, the non-silicone surfactant being Surfynol PSA.

In some embodiments the ink formulation of the invention comprises at least one surfactant being a surfactant of a first type i.e., a silicone surfactant, selected from the group consisting of Byk 349, BYK 348, BYK-3456, BYK-3455 and any combination thereof, wherein the ink formulation optionally further comprises at least one surfactant of a second type i.e., being a non-silicone surfactant, the non-silicone surfactant being Surfynol PSA.

In some embodiments the ink formulation of the invention comprises at least one surfactant of a first type being BYK-3456 and at least one surfactant of a second type being Surfynol PSA.

In some embodiments, the at least one surfactant is present in the water-based inkjet ink formulation according to the present invention at a concentration of between about 0.1 w/w % to about 3.0 w/w %, inclusive. Any value within the above concentration range is within the scope of the present invention e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 and 3.0 w/w %.

In some embodiments, the at least one surfactant is present in the water-based inkjet ink formulation according to the present invention at a concentration of between about 0.5 w/w % to about 3.0 w/w %, inclusive.

In some embodiments, the at least one surfactant is present in the water-based inkjet ink formulation according to the present invention at a concentration of between about 0.5 w/w % to about 2.5 w/w %, inclusive.

In some embodiments, the at least one surfactant is a surfactant of a first type i.e., a silicone surfactant, being present in the water-based inkjet ink formulation according to the present invention at a concentration of between about 0.1 w/w % to about 3.0 w/w %, inclusive. Any value within the above concentration range is within the scope of the present invention e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 and 3.0 w/w %. At times, the surfactant of a first type i.e., a silicone surfactant, is present in the water-based inkjet ink formulation according to the present invention at a concentration of between about 0.5 w/w % to about 3.0 w/w %, inclusive, at times at a concentration of between about 1.0 w/w % to about 3.0 w/w %, inclusive, even at times at a concentration of between about 0.5 w/w % to about 2.5 w/w %, inclusive.

In some embodiments, the at least one surfactant is a surfactant of a second type i.e., a non-silicone surfactant, being present in the water-based inkjet ink formulation according to the present invention at a concentration of between about 0.1 w/w % to about 0.5 w/w %, inclusive. Any value within the above concentration range is within the scope of the present invention e.g., 0.1, 0.2, 0.3, 0.4 and 0.5 w/w %.

In some embodiments, the at least one surfactant is a surfactant of a first type i.e., a silicone surfactant, being present in the water-based inkjet ink formulation according to the present invention at a concentration of between about 0.1 w/w % to about 3.0 w/w %, inclusive, at times at a concentration of between about 1.0 w/w % to about 3.0 w/w %, inclusive, even at times at a concentration of between about 0.5 w/w % to about 2.5 w/w %, inclusive, and the surfactant of a second type i.e., a non-silicone surfactant, optionally being present in the water-based inkjet ink formulation according to the present invention at a concentration of between about 0.0 w/w % to about 0.5 w/w %, inclusive.

In some embodiments, the ink formulations according to the invention comprise at least one surfactant of a first type (i.e., a silicone surfactant) and at least one surfactant of a second type (i.e., a non-silicone surfactant), wherein the first type and second type surfactants are present in the ink formulation at a ratio of between about 4:1 to about 200:1, inclusive. Any value within the above ratios is within the scope of the present invention.

In some embodiments the total content of the surfactants in the ink formulations of the invention is about 4.0 w/w %, at times about 3.5%, at times about 3.0%, event at times about 2.5%.

In some embodiments of the invention the at least one surfactant is of a first type, selected to obtain the dynamic surface tension and the static surface tension of the ink formulation as herein disclosed.

In some embodiments of the invention the at least one surfactant is of a second type, selected to obtain the dynamic surface tension and the static surface tension of the ink formulation as herein disclosed.

In some embodiments of the invention the ink formulation of the invention comprises the first and the second type surfactants, wherein the combination thereof is selected to obtain the dynamic surface tension and the static surface tension of the ink formulation as herein disclosed.

In some embodiments the surfactants of the present invention are fully soluble in the water ink formulations of the invention.

In some embodiments, the at least one surfactant and the content thereof in the ink formulations according to the invention is as herein disclosed and exemplified.

In some embodiments, the ink formulations according to the invention are as herein disclosed and exemplified.

The water-based inkjet ink formulation of the present invention are aqueous inks. In some embodiments the water constitutes at least about 30 w/w % of the formulation, at times at least about 40 w/w %, event at times at least about 50 w/w % or more.

In some embodiments according to the present invention, the water constitutes between about 30.0 w/w % to about 65.0 w/w %, 30.0 w/w % and 65.0 w/w %, inclusive, of the ink formulation. Any value within the above concentration range is within the scope of the present invention e.g., 30.0, 31.0, 32.0, 33.0, 34.0, 35.0, 36.0, 37.0, 38.0, 39.0, 40.0, 41.0, 42.0, 43.0, 44.0, 45.0, 46.0, 47.0, 48.0, 49.0, 50.0, 51.0, 52.0, 53.0, 54.0, 55.0, 56.0, 57.0, 58.0, 59.0, 60.0, 61.0, 62.0, 63.0, 64.0 and 65.0 w/w %.

In some embodiments according to the present invention, the water constitutes between about 45.0 w/w % to about 65.0 w/w %, 45.0 w/w % and 65 w/w %, inclusive, of the ink formulation.

In some embodiments the water-based inkjet ink formulation of the present invention may further comprise at least one co-solvent e.g., humectant.

In some embodiments the water-based inkjet ink formulation of the present invention may optionally further comprise one or more water-miscible co-solvents.

In some embodiments the ink formulation according to the present invention may further comprise at least one co-solvent. In some embodiments, the co-solvent is miscible with the water. In some embodiments the co-solvent is miscible with water at the at least one particular temperature in the range of 20° C. to 60° C., whereby the solvent is a single-phase solvent. In some embodiments, the co-solvent is selected to provide the single-phase solvent with a reduced vapor pressure relative to water at the at least one particular temperature in the range of 20° C. to 60° C. In some embodiments, the co-solvent is selected from the group consisting of ethylene glycol, diethylene glycol, propylene glycol, glycerol, PEG 400, N-methyl pyrrolidone, and mixtures thereof. In some embodiments the, the co-solvent is selected from the group consisting of dipropylene glycol, tripropylene glycol methyl ether, DMSO, and mixtures thereof. In some embodiments, the co-solvent constitutes at least 5%, at least 10%, at least 15%, at least 20%, at least 25%, at least 30%, at least 35%, or at least 40% w/w/of the formulation. In some embodiments, the co-solvent constitutes not more than 40%, not more than 35%, not more than 30%, not more than 25%, not more than 20%, not more than 15%, not more than 10%, or not more than 5% w/w/ of the formulation. In some embodiments, the ratio of co-solvent to water, on a weight-weight basis, is within the range of 0.1:1 to 1:1. Any value within the above ratio is within the scope of the present invention.

In some embodiments according to the present invention, the co-solvent is present in the water-based inkjet ink formulation according to the present invention at a concentration of between about 12.0 w/w % to about 25.0 w/w %, 12.0 w/w % and 25.0 w/w % inclusive. Any value within the above concentration range is within the scope of the present invention e.g., 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, and 25.0 w/w %.

In some embodiments the co-solvent is propylene glycol.

As used herein the terms “colorant” and “coloring agent” or any lingual variations thereof are interchangeable.

In some embodiments, the colorant constitutes at least about 1.0% w/w of the ink formulation.

In some embodiments, the colorant comprises a pigment or a mixture of pigments.

In some embodiments according to the present invention, the at least one colorant is present in the water-based inkjet ink formulation according to the present invention at a concentration of between about 0.1 w/w % to about 5.0 w/w %, 0.1 w/w % and 5.0 w/w % inclusive. Any value within the above concentration range is within the scope of the present invention e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0 w/w %.

In some embodiments according to the present invention, the total concentration of the colorant/s in the water-based inkjet ink formulation according to the present invention is of between about 0.1 w/w % to about 5.0 w/w %, 0.1 w/w % and 5.0 w/w % inclusive. Any value within the above concentration range is within the scope of the present invention e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0 w/w %.

In some embodiments, the colorant contains less than 5% pigment.

In some embodiments according to the present invention the colorant comprises at least one white pigment.

In some embodiments according to the present invention the colorant comprises at least one black pigment.

In some embodiments the at least one colorant is dispersed or at least partly dissolved in the water and the optional at least one co-solvent.

In some embodiments the ink formulation according to the present invention may further comprise at least one plasticizer.

Non limiting examples of plasticizing agents include Pluronic 10R5 (BASF), Pluronic 10RP (BASF), GRB-3 (Lubrizol), Byketol PC (BYK), Carbowax 1450 (DOW), Carbowax 3250 (Dow), Tergiltol 15-5-9 (Sigma-Aldrich), Tween 20, Tween 80, Ecosurf SA-9 (DOW), Ecosurf EH-9 (DOW), Synative RPE1050 (BASF) or any combinations thereof. Any other plasticizing agents known in the art are within the scope of the present invention.

In some embodiments the ink formulation of the invention comprises at least one plasticizer being of a poly(ethylene glycol) nature e.g., Carbowax 1450 (DOW) and Carbowax 3250 (Dow).

In some embodiments the ink formulation of the invention comprises at least one pluronic plasticizer being a Poly(ethylene glycol)-Poly(propylene glycol)-Poly(ethylene glycol) copolymer (i.e., PPG-PEG-PPG copolymer).

In some embodiments the ink formulation of the invention comprises at least one pluronic plasticizer being of a Mw of between about 1,000 g/mole to about 5,000 g/mole, inclusive. Any value within the above range is within the scope of the present invention e.g., a Mw of about 1,000, about 2,000, about 3,000, about 4,000, and of about 5,000 g/mole.

In some embodiments the ink formulation of the invention comprises a Pluronic plasticizer e.g., Pluronic 10R5 (BASF) and Pluronic 10RP (BASF).

In some embodiments the ink formulation of the invention comprises a plasticizer being a secondary alcohol ethoxylatethe e.g., Tergiltol 15-S-9 (Sigma-Aldrich) plasticizer.

In some embodiments the ink formulation of the invention comprises a plasticizer being an ethoxylated (20) sorbitan ester e.g., Tween 20 and Tween 80.

In some embodiments the ink formulation of the invention comprises a plasticizer being a modified urea surfactant plasticizer e.g., Byketol PC (BYK).

In some embodiments the ink formulation of the invention comprises a plasticizer being an alcohol ethoxylate e.g., Ecosurf EH-9 (DOW).

In some embodiments the ink formulation of the invention comprises a plasticizer being a seed oil surfactant e.g., Ecosurf SA-9 (DOW).

In some embodiments the ink formulation of the invention comprises a plasticizer consisting black copolymers of polyethylene oxide and polypropylene oxide e.g., Synative RPE1050 (BASF) plasticizer.

In some embodiments the ink formulation of the invention comprises a polyol plasticizer e.g., GRB-3 (Lubrizol).

In some embodiments the ink formulation of the invention comprises the combination of the plasticizers GRB-3 and Byketol PC.

In some embodiments according to the present invention, the least one plasticizer is present in the water-based inkjet ink formulation according to the present invention at a concentration of between about 2.0 w/w % to about 6.0 w/w %, 2.0 w/w % and 6.0 w/w % inclusive. Any value within the above concentration range is within the scope of the present invention e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 2.8, 5.9 and 6.0 w/w %.

In some embodiments according to the present invention, the total content of the plasticizer/s present in the water-based inkjet ink formulation according to the present invention is between about 2.0 w/w % to about 6.0 w/w %, 2.0 w/w % and 6.0 w/w % inclusive. Any value within the above concentration range is within the scope of the present invention e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 2.8, 5.9 and 6.0 w/w %.

In some embodiments the ink formulation according to the present invention may further comprise at least one dispersant.

Non limiting examples of applicable dispersants are polyanionic and polymeric dispersing agents.

In some embodiments the dispersant is Efka 4585 (Evonik).

In some embodiments according to the present invention, the least one dispersant is present in the water-based inkjet ink formulation according to the present invention at a concentration of between about 1.0 w/w % to about 4.0 w/w %, 1.0 w/w % and 4.0 w/w % inclusive. Any value within the above concentration range is within the scope of the present invention e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.1, 3.2, 3.3, 3.4, 3.5, 3.6, 3.7, 3.8, 3.9 and 4.0 w/w %.

In some embodiments the water-based inkjet ink formulation of the invention may further comprise at least one anti-corrosion agent.

In some embodiments the anti-corrosion agent is L-51—Levasil CC151HS.

In some embodiments the anti-corrosion agent is an alkali-metal organosiliconate.

Such anti-corrosion agents have been previously disclosed in the patent publications to the Applicant [11], the content thereof is incorporated herein by reference.

In some embodiments according to the present invention, the at least one alkali-metal organosiliconate is sodium methylsiliconate which at times may be referred to as methyl-silanetriosodiumsalt or sodium methylsilanetriolate.

In some embodiments according to the present invention, the at least one alkali-metal organosiliconate is sodium methylsiliconate being of CAS No. of 16589-43-8.

In some embodiments according to the present invention, the at least one alkali-metal organosiliconate is potassium methyl siliconate which at times may be referred to as methylsilanetriol potassium salt or potassium methylsilanetriolate.

In some embodiments according to the present invention, the at least one alkali-metal organosiliconate is potassium methyl siliconate being of CAS No. of 31795-24-1.

In some embodiments, the at least one alkali-metal organosiliconate is present in the water-based inkjet ink formulation according to the present invention at a concentration of at least about 0.01 w/w %, at times of at least about 0.05 w/w %, even at times of at least about 0.1 w/w %.

In some embodiments, the at least one alkali-metal organosiliconate is present in the water-based inkjet ink formulation according to the present invention at a concentration of between about 0.01 w/w % to about 4.00 w/w %, 0.01 and 4.00 w/w % inclusive. Any value within the above concentration range is within the scope of the present invention e.g., 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, 1.00, 1.10, 1.20, 1.30, 1.40, 1.50, 1.60, 1.70, 1.80, 1.90, 2.00, 2.10, 2.20, 2.30, 2.40, 2.50, 2.60, 2.70, 2.80, 2.90, 3.00, 3.10, 3.20, 3.30, 3.40, 3.50, 3.60, 3.70, 3.80, 3.90 and 4.00 w/w %.

In some embodiments the water-based inkjet ink formulation of the invention may further comprise at least one antibacterial agent (biocide) (e.g., Merga K12N or any other antibacterial agent known in the art), wherein the antibacterial agent making up at most about 1%, by weight, of the inkjet ink formulation. Any value between 0 to 1% is within the scope of the present invention.

In some embodiments of the invention, the antibacterial agent makes about 0.03%, by weight, of the inkjet ink formulation.

In some embodiments the water-based inkjet ink formulation of the invention may further comprise at least one wax material. Non limiting examples of the wax material include Deurex 4501, Deurex 4601, Novasperse HD80 (Allinova), Joncryl wax 35 (BASF), Cohesa 1020 (Honeywell), Aquaver 513 (BYK), or any combination thereof. Any other wax materials known in the art are within the scope of the present invention.

In some embodiments at least one wax material is an oxidized polyethylene wax e.g., Deurex 4501 and Deurex 4601.

In some embodiments at least one wax material is a High Density Polyethylene (HDPE) wax e.g., Novasperse HD80 (Allinova) and Aquaver 513 (BYK).

In some embodiments at least one wax material is a polyethylene wax e.g., Joncryl wax 35 (BASF).

In some embodiments at least one wax material comprises an ethylene-acrylic acid copolymer e.g., Cohesa 1020 (Honeywell).

In some embodiments the wax material is provided in the form of an emulsion e.g., wax in water emulsion.

In some embodiments the wax material making up at most about 3.0%, by weight, of the inkjet ink formulation, at times at most about 5.0%, by weight, of the inkjet ink formulation. Any value between 0 to 5.0% is within the scope of the present invention, e.g., 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0 w/w %.

In some embodiments the ink formulation according to the present invention may further comprise at least one further additive applicable in the filed of inkjet inks. Non limiting examples of applicable additives are: at least one anti gelation agent (e.g., an acid); at least one pH controlling agent (e.g., a base); and at least one antifoaming agent.

In some embodiments one or more of the further additives make up at most about 3.0%, by weight, of the inkjet ink formulation. Any value between 0 to 3.0% is within the scope of the present invention e.g., 0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 and 3.0 w/w %.

In some embodiments the ink formulations of the invention may comprise one or more non-volatile solids.

In some embodiments the non-volatile solids make up at most about 30% by weight, at times at most about 25.0%, even at times at most about 20.0%, by weight, of the inkjet ink formulation.

In some embodiments the non-volatile solids constitute between about 10% w/w to about 30% w/w of the inkjet ink formulation, at times between about 10% w/w to about 20.0% w/w of the inkjet ink formulation, event at times between about 15% w/w to about 22% w/w of the inkjet ink formulation.

In some embodiments of the invention the at least one surfactant of the present invention and one or more further ingredient in the ink formulation (e.g., at least one alkali-metal organosiliconate) may provide an additive effect, at times a synergistic beneficial effect in the printing process of the invention. Non limiting beneficial effects are as herein disclosed.

In some embodiments, e.g., when the water-based inkjet ink formulation is use in an indirect printing process or system, the water-based inkjet ink formulation may further comprise at least one binder (e.g., organic polymeric resin).

In some embodiments the at least one binder may be dispersed or at least partly dissolved in the water and optional co-solvent.

In some embodiments the at least one binder is dispersed or at least partly dissolved in the water and optional co-solvent.

In some embodiments the at least one binder is an organic polymeric resin binder.

In some embodiments the at least one binder is an organic polymeric resin binder, dispersed or at least partly dissolved in the water and optional co-solvent.

In some embodiments according to the present invention, the at least one binder in the ink formulation is an anionic binder e.g., an acrylic binder and/or a sulfonic binder. Similar anionic binders are within the scope of the present invention.

In some embodiments according to the present invention, the at least one binder in the ink formulation is a negatively charged organic polymeric resin.

In some embodiments according to the present invention, the average molecular weight of the negatively charged organic polymeric resin is at least 8,000.

In some embodiments according to the present invention, the at least one binder in the ink formulation is an acrylic polymer and/or an acrylic-styrene co-polymer (e.g., with an average molecular weight around 60,000 g/mole).

In some embodiments according to the present invention, the least one binder is present in the water-based inkjet ink formulation according to the present invention at a concentration of between about 5.0 w/w % to about 20.0 w/w %, 5.0 w/w % and 20.0 w/w % inclusive. Any value within the above concentration range is within the scope of the present invention e.g., 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 16.0, 17.0, 18.0, 19.0 and 20.0 w/w %.

Non limiting examples of binders include polystyrene-acrylate co-polymers, poly-acrylate polymers, polyurethanes (e.g., aliphatic polyurethanes such as anionic aliphatic polyurethanes), urethane-acrylate co-polymers, and polyesters (e.g., a polyethylene terephthalate).

Exemplary styrene-acrylic (or polystyrene-acrylate) copolymers include Joncryl® 77E, Joncryl® 586, Joncryl® 90, Joncryl® 8085, and Joncryl® ECO 2177.

Exemplary polyurethane includes NeoRez® R-563, an anionic aliphatic polyurethane from DSM-PUD.

Exemplary acrylic or polyacrylic binders include Joncryl® 538 (BASF) an acrylic polymer emulsion.

Exemplary polyesters include Plascoat Z-105, Plascoat Z-730, and Plascoat Z-750 (all from GOO Chemicals).

The binders may be provided in various forms, such as dispersions or emulsions, with water typically being the major carrier liquid.

In some embodiments the binder is styrene-acrylic emulsion.

In some embodiments the ink formulations of the invention may comprise one or more of: at least one co-solvent, at least one plasticizer, at least one dispersant, at least one anti-corrosion agent, at least one antibacterial agent, at least one wax material, at least one anti gelation agent, at least one pH controlling agent, at least one antifoaming agent and at least one binder.

The various embodiments detailed herein in connection with the inkjet ink formulations of the invention are applicable mutatis mutandis to the uses, methods and systems of the invention.

In another one of its aspects, the present invention provides a water-based inkjet ink formulation as herein disclosed, for use in preventing and/or minimizing and/or mitigating inkjet ink sweating on the print head of a printing system. The print head/s are used in a printing process which may be direct or indirect. Similarly, the utilized printing systems may be either direct or indirect systems.

In some embodiments the water-based inkjet ink formulation as herein disclosed are also used for improving the printing process and/or improving the quality of the resulted printed image. The printing process may be direct or indirect.

In some embodiments the ink formulations of the present invention are applicable to the jetting temperature of the printing processes according to the present invention (e.g., about 30° C.) as well as to other temperatures operated in the process (e.g., ITM temperature of about 80° C.).

In a further one of its aspects the present invention provides a method for preventing and/or minimizing and/or mitigating inkjet ink sweating on the print head of a printing system (e.g., the print head being used in an inkjet printing process and forms part of a printing system), wherein said method comprises utilizing (e.g., in the printing process) a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension, to thereby prevent and/or minimize and/or mitigate inkjet ink sweating on the print head of a printing system.

In another one of its aspects the present invention provides a method for preventing and/or minimizing and/or mitigating inkjet ink sweating on the print head of a printing system (e.g., the print head being used in an inkjet printing process and forms part of a printing system), wherein said method comprises utilizing the water-based inkjet ink formulation of the invention, as herein disclosed.

In a further one of its aspects the present invention provides a water-based inkjet ink formulation as herein disclosed, for use in a method for preventing and/or minimizing and/or mitigating inkjet ink sweating on the print head of a printing system.

Yet, in a further one of its aspects the present invention provides a water-based inkjet ink formulation as herein disclosed, for use in preventing and/or minimizing and/or mitigating inkjet ink sweating on the print head of a printing system.

In a further one of its aspects the present invention provides a method for one or more of improving a printing process and improving the quality of the resulted printed image, wherein said method comprises utilizing (e.g., in the printing process) a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension, to thereby improve one or more of the printing process and the quality of the resulted printed image.

In another one of its aspects the present invention provides a method for one or more of improving a printing process and improving the quality of the resulted printed image, the method comprising utilizing in the printing process the water-based inkjet ink formulation as herein disclosed.

In a further one of its aspects the present invention provides a water-based inkjet ink formulation as herein disclosed, for use in a method for one or more of improving a printing process and improving the quality of the resulted printed image.

Yet, in a further one of its aspects the present invention provides a water-based inkjet ink formulation as herein disclosed, for use in one or more of improving a printing process and improving the quality of the resulted printed image.

Non limiting examples of improvements achieved by the ink formulations of the present invention are one or more of improved jetting stability over a long period of time, more available printing cycles/runs (inter-alia due to reduced accumulations of the ink in the ink nozzle); improved print heads life span; ease of maintenance; improved process stability; and improved printing quality being one or more of improvement in the uniformity of printing, ink wetting on the ITM, dot size, ink spreading characteristics, missing nozzles compensation and print head compatibility.

In some embodiments, improving the printing process and/or improving the quality of the resulted printed image is reflected in the non-sweating behavior of the ink formulations of the invention.

In another one of its aspects the present invention provides a water-based inkjet ink formulation as herein disclosed, for use in a printing process e.g., as herein described.

In a further one of its aspects the present invention provides a water-based inkjet ink formulation as herein disclosed, said formulation forming part of a printing system e.g., as herein described.

In yet a further one of its aspects the present invention provides a printing method utilizing the water-based inkjet ink formulation as herein disclosed.

Yet, in a further one of its aspects the present invention provides a method of printing on a substrate, the method comprises ink-jetting an ink formulation onto a printing substrate by utilizing one or more print bars, each of which comprises one or more print heads, to thereby form ink images on said substrate, wherein the ink formulation is the water-based inkjet ink formulation according to the invention.

In some embodiments the printing method of the invention is for one or more of improving a printing process and improving the quality of a resulted printed image.

In another one of its aspects the present invention provides a printing method comprising:
providing an intermediate transfer member comprising a release layer surface;
ink-jetting an ink formulation onto said release layer surface by utilizing one or more print bars, each of which comprises one or more print heads, to thereby form ink images on said release layer surface; and
transferring said ink images from the intermediate transfer member to a printing substrate;
wherein said ink formulation is the water-based inkjet ink formulation according to the invention.

In some embodiments the method may further comprise substantially drying the ink images formed on the intermediate transfer member and transferring the substantially dry ink images from the intermediate transfer member to a printing substrate.

In a further one of its aspects the present invention provides a method of printing being selected from:
(i) a direct method of printing on a substrate, the method comprises ink-jetting an ink formulation onto a printing substrate by utilizing one or more print bars, each of which comprises one or more print heads, to thereby form ink images on said substrate, wherein the ink formulation is the water-based inkjet ink formulation according to the invention; or
(ii) an indirect method of printing, the method comprises:
   providing an intermediate transfer member comprising a release layer surface;
   ink-jetting an ink formulation onto said release layer surface by utilizing one or more print bars, each of which comprises one or more print heads, to thereby form ink images on said release layer surface; and
   transferring said ink images from the intermediate transfer member to a printing substrate;
   wherein said ink formulation is the water-based inkjet ink formulation according to the invention, and wherein the method may further comprise substantially drying the ink images formed on the intermediate transfer member, and transferring the substantially dry ink images from the intermediate transfer member to a printing substrate.

Yet, in a further one of its aspects the present invention provides a printing system comprising the water-based inkjet ink formulation as herein disclosed.

In another one of its aspects the present invention provides a printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation according to the present invention.

In a further one of its aspects the present invention provides a printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation according to the present invention; and
a transfer station for transferring the ink images from the intermediate transfer member to a printing substrate.

In yet a further one of its aspects the present invention provides a printing system and a printing process substantially as herein described.

Yet in a further one of its aspects the present invention provides water-based inkjet ink formulations substantially as herein described.

In another one of its aspects the present invention provides water-based inkjet ink formulations with dynamic surface tension and static surface tension as herein exemplified and illustrated in the figures.

As noted above, the inkjet ink formulations of the present invention may be used in a direct or an indirect printing process utilizing direct and indirect printing system, respectively.

In some embodiments the printing process is a direct printing process i.e., the ink formulation is directly jetted onto a final printed subtract.

In some embodiments the printing process is an indirect printing process in which a release surface of an intermediate transfer member (ITM) is pre-treated (e.g., coated) with a treatment formulation (e.g., an aqueous treatment formulation) before deposition of an ink image thereto. The treatment formulation is applied to a surface of an ITM to form thereon a thin wet treatment layer which is subjected to a drying process on the ITM release surface to leave a thin substantially dried treatment layer (which may be in a form of a film or a non-film form e.g., a non-cohesive treatment layer) on the ITM release surface. Then after, droplets of the aqueous ink formulation are deposited by ink-jetting onto the thin substantially dried treatment layer (e.g., film or non-film) to form an ink image thereon. The formed ink-image is then subjected to a drying process to leave an ink residue on the substantially dried treatment layer. The substantially dried ink-image is then transferred, together with the thin substantially dried treatment layer, from the ITM surface to a final printed substrate (e.g., foil-based, paper-based or plastic-based).

Examples of such printing processes and systems are disclosed in the patent publications to the Applicant WO 2017/208152 (PCT/IB2017/053177) [3] and WO 2013/132418 (PCT/IB2013/051716) [4], and in patent application No. PCT/IL2023/050117 [12] to the Applicant. The content of each is incorporated herein by reference. Further, examples of applicable treatment formulations are disclosed in the patent publication to the Applicant WO 2020/141465 (PCT/IB2020/050001) [10] and in patent application No. PCT/IL2023/050117 [12] to the Applicant, the content of each is incorporated herein by reference.

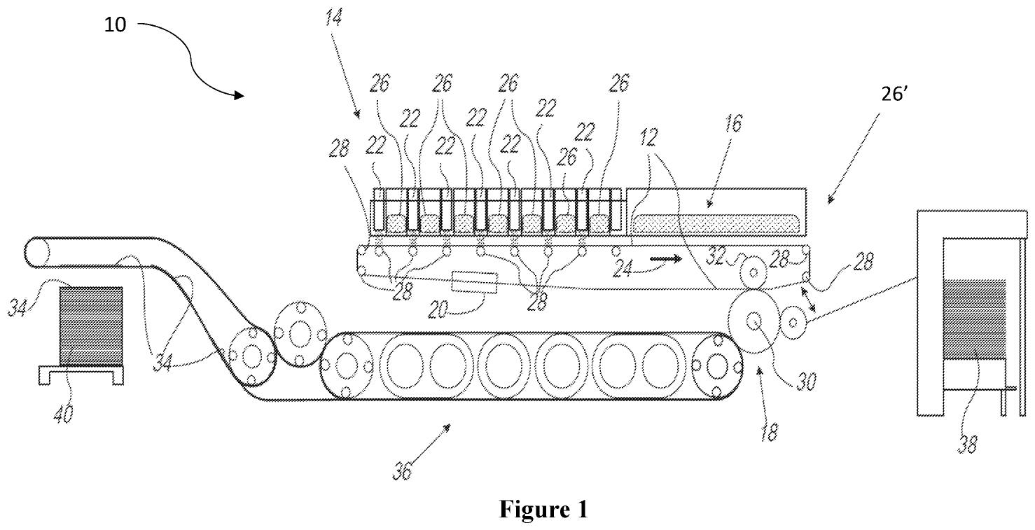

Briefly, FIG. 1 provides an illustration of an exemplary indirect printing system. Specifically, FIG. 1 is a schematic side view of a digital printing system 10, in accordance with some embodiments of the invention. In some embodiments, system 10 comprises a rolling flexible blanket 12 that cycles through an image forming station 14, a drying station 16, an impression station 18 and a blanket treatment station 20.

As used herein the term “blanket” refers to a flexible transfer member that can be mounted within a printing device to form a belt-like structure on two or more rollers, at least one of which is able to rotate and move the blanket (e.g., by moving the belt thereof) to travel around the rollers.

As used herein, the terms “blanket” and “intermediate transfer member” (ITM) are used interchangeably and refer to a flexible member comprising at least a release layer used as an intermediate member configured to receive an ink image and to transfer the ink image to a target substrate.

In an operative mode, image forming station 14 is configured to form a mirror ink image, also referred to herein as “an ink image” (not shown), of a digital image on an upper run of a surface of blanket 12. Subsequently the ink image is transferred to a target substrate, (e.g., a paper, a folding carton, or any suitable flexible package in a form of sheets or continuous web) located under a lower run of blanket 12.

As used herein, the terms “ink image” and “image” are interchangeable. At times, said terms refer to an image formed on blanket 12 and transferred to a target substrate. At times they refer to the printed image on the substrate itself (e.g., a paper, a folding carton, or any suitable flexible package in a form of sheets or continuous web). Thus, these terms should be interpreted in the context of the text in which they are used.

As used herein, the term “run” refers to a length or segment of blanket 12 between any two given rollers over which blanket 12 is guided.

In some embodiments, during installation blanket 12 may be adhered (e.g., seamed) edge to edge to form a continuous blanket loop (not shown). An example of a method and a system for the installation of the seam is described in detail in the patent publication to the Applicant WO 2019/012456 (PCT/IB2018/055126) [5], the disclosure thereof is incorporated herein by reference.

In some embodiments, image forming station 14 typically comprises multiple print bars 22, each mounted (e.g., using a slider) on a frame (not shown) positioned at a fixed height above the surface of the upper run of blanket 12. In some embodiments, each print bar 22 comprises a strip of print heads as wide as the printing area on blanket 12 and comprises individually controllable print nozzles.

In some embodiments, image forming station 14 may comprise any suitable number of bars 22, each bar 22 may contain a printing fluid, such as an aqueous ink formulation of a different color. The ink typically has visible colors, such as but not limited to cyan, magenta, red, green, blue, yellow, black and white. In the example of FIG. 1, image forming station 14 comprises seven print bars 22, but may comprise, for example, four print bars 22 having any selected colors such as cyan, magenta, yellow and black.

In some embodiments, one or more of the print bars may comprise the water-based inkjet ink formulation of the invention. At times, all of the print bars utilized in the printing method/system may comprise the water-based inkjet ink formulation of the invention.

In some embodiments, the print heads are configured to jet ink droplets of the different colors onto the surface of blanket 12 so as to form the ink image (not shown) on the surface of blanket 12.

In some embodiments, different print bars 22 are spaced from one another along the movement axis of blanket 12, represented by an arrow 24. In this configuration, accurate spacing between bars 22, and synchronization between directing the droplets of the ink of each bar 22 and moving blanket 12 are essential for enabling correct placement of the image pattern.

In some embodiments, system 10 comprises heaters, such as hot gas or air blowers 26, which are positioned in between print bars 22, and are configured to partially dry the ink droplets deposited on the surface of blanket 12.

This hot air flow between the print bars may assist, for example, in reducing condensation at the surface of the print heads and/or in handling satellites (e.g., residues or small droplets distributed around the main ink droplet), and/or in preventing blockage of the inkjet nozzles of the print heads, and/or in preventing the droplets of different color inks on blanket 12 from undesirably merging into one another. In some embodiments, system 10 comprises a drying station 16, configured to blow hot air (or another gas) onto the ink image on the surface of blanket 12. In some embodiments, drying station comprises air blowers or any other suitable drying apparatus, such as IR dryers.

In drying station 16, the ink image formed on blanket 12 is exposed to radiation and/or to hot air in order to dry the ink more thoroughly, evaporating most or all of the liquid carrier and leaving behind only a layer of resin and coloring agent which is heated to the point of being rendered tacky ink film.

In some embodiments, system 10 comprises a blanket transportation assembly 26′, configured to move a rolling ITM, such as a blanket 12. In some embodiments, blanket transportation/guiding assembly 26′ comprises one or more rollers 28, wherein at least one of rollers 28 comprises an encoder (not shown), which is configured to record the position of blanket 12, so as to control the position of a section of blanket 12 relative to a respective print bar 22. In some embodiments, the encoder of roller 28 typically comprises a rotary encoder configured to produce rotary-based position signals indicative of an angular displacement of the respective roller.

Additionally or alternatively, blanket 12 may comprise an integrated encoder (not shown) for controlling the operation of various modules of system 10. The integrated encoder is described in detail, for example, in the patent publication to the Applicant WO 2020/003088 (PCT/IB2019/055288) [6], the disclosure thereof is incorporated herein by reference.

In some embodiments, system 10 comprises an impression station 18, wherein blanket 12 passes between an impression cylinder 30 and a pressure cylinder 32, which are pressed to transfer the image carried by the blanket 12 to the substrate 38, as detailed below.

In some embodiments, system 10 comprises a control console (not shown), which is configured to control multiple modules and assemblies of system 10.

In some embodiments, blanket treatment station 20, which can also serve as a cooling and/or cleaning station, is configured to treat the blanket by, for example, cooling it and/or applying a treatment fluid to the outer surface of blanket 12, and/or cleaning the outer surface of blanket 12. The treatment may be carried out by passing blanket 12 over one or more rollers or blades configured for applying cooling and/or cleaning and/or treatment fluid on the outer surface of the blanket.

In the example of FIG. 1, station 20 is mounted between two specific rollers 28, yet, station 20 may be mounted adjacent to blanket 12 at any other suitable location between impression station 18 and image forming station 14.

In some embodiments, impression cylinder 30 of impression station 18, is configured to impress the ink image onto the target substrate, such as an individual sheet 34 or continuous web substrate, conveyed by substrate transport module 36 (schematically shown) from an input stack 38 to an output stack 40 via impression cylinder 30. In some embodiments, the target substrate may comprise any suitable substrate, such as but not limited to a flexible substrate, a partially flexible substrate (e.g., having flexible sections and rigid sections), or a rigid substrate.

In some embodiments, system 10 comprises an additional impression station (not shown), so as to permit duplex printing (i.e., printing on both sides of sheet 34).

In alternative embodiments, a different configuration of substrate conveyor 36 may be used for printing on a continuous web substrate, as disclosed for example in PCT International Publication WO 2020/136517 (PCT/IB2019/061081) [9]. Detailed descriptions and various configurations of sheet-fed simplex and duplex printing systems and of systems for printing on continuous web substrates are provided, for example, in PCT International Publications WO 2013/132420 (PCT/IB2013/051718) [7] and in PCT International Publication WO 2015/036906 (PCT/IB2014/064277) [8], the disclosure of each is incorporated herein by reference.

The particular configurations of system 10 are shown by way of example. Embodiments of the present invention, however, are by no means limited to this specific sort of example system, and the principles described herein may similarly be applied to any other sorts of printing systems.

Thus, in another one of its aspects, the present invention provides an indirect printing system and an indirect printing process e.g., as described in one or more of [3], [4] and [12], utilizing the inkjet ink formulations of the present invention.

In a further one of its aspects the present invention provides a printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation according to the present invention.

In some embodiments the printing substrate is substantially as disclosed herein.

In some embodiments the one or more print heads are substantially as disclosed herein.

Yet, in a further one of its aspects the present invention provides a printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation according to the present invention; and
a transfer station for transferring the ink images from the intermediate transfer member to a printing substrate.

In some embodiments the system of the invention may further comprise a drying station configured to substantially dry (at times partly dry) the ink images formed on the intermediate transfer member, and wherein the transfer station is configured to transfer the substantially dry (at times partly dry) ink image from the intermediate transfer member to a printing substrate.

As used herein above and below, the term “substantially dry” or any lingual variations thereof may be envisaged as partly dry, at times as dry to an extend that solvent/s and/or co-solvent/s and/or water and/or any volatile ingredient/s are present at traces amounts (e.g., that are not interfering with the performance of one or more of the system, the printing process and the printing quality), or even at times as completely dry.

In some embodiments the intermediate transfer member is substantially as disclosed herein.

In some embodiments the one or more print heads are substantially as disclosed herein.

In some embodiments the transfer station is substantially as disclosed herein.

In some embodiments the drying station is substantially as disclosed herein.

In some embodiments the printing substrate is substantially as disclosed herein.

In some embodiments the print head of the present invention forms part of a direct printing system.

In some embodiments the print head of the present invention is an inkjet print head.

In some embodiments the print head of the present invention forms part of an indirect direct printing system.

In some embodiments the print head of the present invention comprises a print head nozzle plate.

The printing heads of the present invention, e.g., printing head, are available for example from Dematix, FUJIFILM Corporation, Tokyo, Japan.

In a further one of its aspects the present invention provides a printing system selected from:
(i) a direct printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation according to the present invention; or
(ii) an indirect printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation according to the present invention; and
a transfer station for transferring the ink images from the intermediate transfer member to a printing substrate, wherein the system may further comprise a drying station configured to substantially dry (at times partly dry) the ink images formed on the intermediate transfer member, and wherein the transfer station is configured to transfer the substantially dry (at times partly dry) ink image from the intermediate transfer member to a printing substrate.

Unless otherwise stated, a “concentration” refers to a w/w—i.e., a weight of a component of the water-based inkjet ink formulation per total weight of the formulation.

As used herein above and below the term “about” refers to ±10% of the indicated value.

In some embodiments the water-based inkjet ink formulation of the invention has a contact angle (CA) as herein exemplified and illustrated e.g., in the figures.

In some embodiments the water-based inkjet ink formulation of the invention has a DST and SST as herein exemplified and illustrated e.g., in the figures.

In some embodiments the water-based inkjet ink formulation of the invention has a viscosity as herein exemplified.

In some embodiments the viscosity of the water-based inkjet ink formulation of the invention is of between about 7.2 cP to about 8.5 cP, at times between about 7.5 cP to about 8.5 cP. Any value within the above ranges is within the scope of the present invention e.g., 7.2, 7.3, 7.4, 7.5, 7.6, 7.7, 7.8, 7.9, 8.0, 8.1, 8.2, 8.3, 8.4, and 8.5.

In some embodiments the water-based inkjet ink formulations are as herein exemplified.

In some embodiments the inkjet ink formulations of the present invention comprise the following ingredients and have the viscosity and static surface tension (SST) as detailed in Table 1 below:

TABLE 1
Ink formulations of the invention (ingredients and parameters
thereof) according to some embodiments of the invention.

| | | Anti corrosion | Viscosity | SST* |
|---|---|---|---|---|
| Formulation | Surfactant | L-51** | (cP) | (mN/m) |
| A | 2% BYK -3456^{#} | 3.33% | 7.21 | 23.8 @ 23.6° C. |
| B | 2% BYK -3456^{#} + | 2.00% | 7.5 | 23.8 @ 24° C. |
| | 0.5% Surfynol PSA | | | |
| | 336^{##} | | | |
| C | 2% BYK -3456^{#} | 2.00% | 7.8 | 23.8 @ 24° C. |
| D | 2% BYK -3456^{#} | 2.00% | 8.2 | 24.7 @ 21° C. |
| E | 2% BYK -3456^{#} | 2.00% | 7.5 | 24.5 @ 21° C. |

*SST—static surface tension, determined by Kruss force tensiometer (K20 model) at a frequency of 5 Hz, RT, as specified.
**L-51—Levasil CC151HS—alkali-metal organosiliconate
^{#}Silicone—surfactant
^{##}Non-silicone—surfactant

In some embodiments the inkjet ink formulations of the present invention have DST and SST as detailed in Table 2 below:

TABLE 2
Ink formulations of the invention and their DST* and SST**,
according to some embodiments of the invention.

| | DST | SST | |
|---|---|---|---|
| Formulation No. | (mN/m) | (mN/m) | Temperature |
| A | 43.3 | 23.6 | 22.5° C. |
| B | 37.7 | 23.7 | 22.0° C. |
| C | 42.2 | 23.7 | 22.0° C. |
| D | 40.1 | 23.7 | 21.5° C. |
| E | 40.1 | 23.5 | 21.5° C. |

*DST measured at a bubble life-time of 0.015 sec, utilizing the Sita bubble pressure tensiometer - Model Sita online (Pro-line T15).
**SST measured at a bubble life-time of 10 sec, utilizing the Sita bubble pressure tensiometer - Model Sita online (Pro-line T15)

### DETAILED DESCRIPTION OF EMBODIMENTS

The following example illustrates inkjet ink formulations according to the teachings of the present disclosure. The example is not in any way intended to limit the scope of the invention as claimed.

### Example 1: Ink Formulations and Properties Thereof

Though the below formulations were prepared using materials supplied under the indicated trademarks, such ingredients can be replaced by other commercially available ingredients e.g., compounds having similar chemical formulas content and other features.

The below ink formulations are black (K) color inks that comprised the following pigments: Heliogen Blue D7079, Black Pearls 4350 and Hostaperm Violet P-RL. Alternative coloring agents (whether pigments or dyes) that may be suitable for such formulations are readily known to persons skilled in the art of formulating printing inks.

The ink formulations were prepared according to general procedures known in the art e.g., See [2](the content of which is incorporated herein by reference).

The viscosity of the ink formulations was measured at room temperature (RT) using viscometer (DV II+Pro by Brookfield).

The dynamic surface tension (DST) was measured using the Sita bubble pressure tensiometer—Model Sita online (Pro-line T15) at RT (as specified, e.g., 21.0° C., 21.5° C., 22.0° C. and 22.5° C.) (Bubble Lifetime, Controlled range 15 ms-20,000 ms, Resolution 1 ms).

The static surface tension (SST) (at bubble lifetime of 10 sec) was also determined using the Sita bubble pressure tensiometer—Model Sita online (Pro-line T15) at RT (as specified, e.g., 21.0° C., 21.5° C., 22.0° C. and 22.5° C.).

The static surface tension was also measured using the standard liquid tensiometer, Kruss force tensiometer (K20 model), at a frequency of 5 Hz, at RT (as specified, e.g., 21.0° C., 23.6° C., 23.8° C., 23.9° C. and 24.0° C.).

The ink contact angle (CA) on a blanket coated with a treatment formulation (See [10]) was measured utilizing CA data physics measurements.

The ink sweating on the PH was comparatively measured by visual inspection of the print heads, accompanied by evaluating the printing quality on the final printed substrate e.g., by counting the missing nozzles at predetermined printing conditions. The missing nozzles are those that did not function well e.g., resulted from nozzle blocking due to ink sweating.

A list of the studied ink formulations and some tested parameters thereof is presented in Table 3 below. The content of the specified ingredients is indicated in weight percent (w/w %) of the stock material, (whether a liquid or solid chemical or a diluted solution, dispersion or emulsion comprising the material of interest) the weight percent being relative to the total weight of the final formulation. It is noted that the formulations included further additive/s known in the filed of inkjet inks.

Table 3 details four ink formulations (1-4) not according to the invention i.e., these ink formulations do not fulfill the DST profile according to the present invention.

Table 3 further details five ink formulations (A-E) according to the invention i.e., these ink formulations fulfill the DST profile according to the present invention.

TABLE 3
Ink Formulations and Parameters

| | Based on | | Anti | | |
|---|---|---|---|---|---|
| Formulation | Formulation | | corrosion | Viscosity | SST* |
| No. | No. | Surfactant | L-51** | (cP) | (mN/m) |
| 1 | — | 1.5% Tego 240^{#} + | 3.33% | 7.74 | 24.2 @ 24° C. |
| | | 1% | | | |
| | | Tego 280^{#} | | | |
| 2 | 1 | 1.5% Tego 240^{#} + | 3.33% | 8.37 | 23.8 @ 23.9° C. |
| | | 1% | | | |
| | | Tego 280^{#} | | | |
| 3 | 1 | 0.6% Tego 240^{#} + | 3.33% | 7.04 | 25.2 @ 23.8° C. |
| | | 0.4% | | | |
| | | Tego 280^{#} | | | |
| 4 | 1 | 2.15% Tego 240^{#} + | 3.33% | 7.7 | 24 @ 24° C. |
| | | 0.35% | | | |
| | | Tego 270^{#} | | | |
| A | 1 | 2% | 3.33% | 7.21 | 23.8 @ 23.6° C. |
| | | BYK -3456^{#} | | | |
| B | | 2% | 2.00% | 7.5 | 23.8 @ 24° C. |
| | | BYK -3456^{#} + | | | |
| | | 0.5% | | | |
| | | Surfynol PSA 336^{##} | | | |
| C | | 2% | 2.00% | 7.8 | 23.8 @ 24° C. |
| | | BYK -3456^{#} | | | |
| D | | 2% | 2.00% | 8.2 | 24.7 @ 21° C. |
| | | BYK -3456^{#} | | | |
| E | | 2% | 2.00% | 7.5 | 24.5 @ 21° C. |
| | | BYK -3456^{#} | | | |

*SST—static surface tension, determined by Kruss force tensiometer (K20 model) at a frequency of 5 Hz, RT, as specified.
**L-51—Levasil CC151HS—alkali-metal organosiliconate
^{#}Silicone—surfactant
^{##}Non-silicone—surfactant

Table 4 below details DST and SST of five ink formulations (A-E) according to the invention.

TABLE 4
Ink Formulations according to the
invention and their DST* and SST**

| | DST | SST | |
|---|---|---|---|
| Formulation No. | (mN/m) | (mN/m) | Temperature |
| A | 43.3 | 23.6 | 22.5° C. |
| B | 37.7 | 23.7 | 22.0° C. |
| C | 42.2 | 23.7 | 22.0° C. |
| D | 40.1 | 23.7 | 21.5° C. |
| E | 40.1 | 23.5 | 21.5° C. |

*DST was measured at a bubble life-time of 0.015 sec, utilizing the Sita bubble pressure tensiometer - Model Sita online (Pro-line T15).
**SST was measured at a bubble life-time of 10 sec, utilizing the Sita bubble pressure tensiometer - Model Sita online (Pro-line T15)

Various properties/parameters of the ink formulations according to the invention were tested and compared to ink formulations which are not in accordance with the present invention.

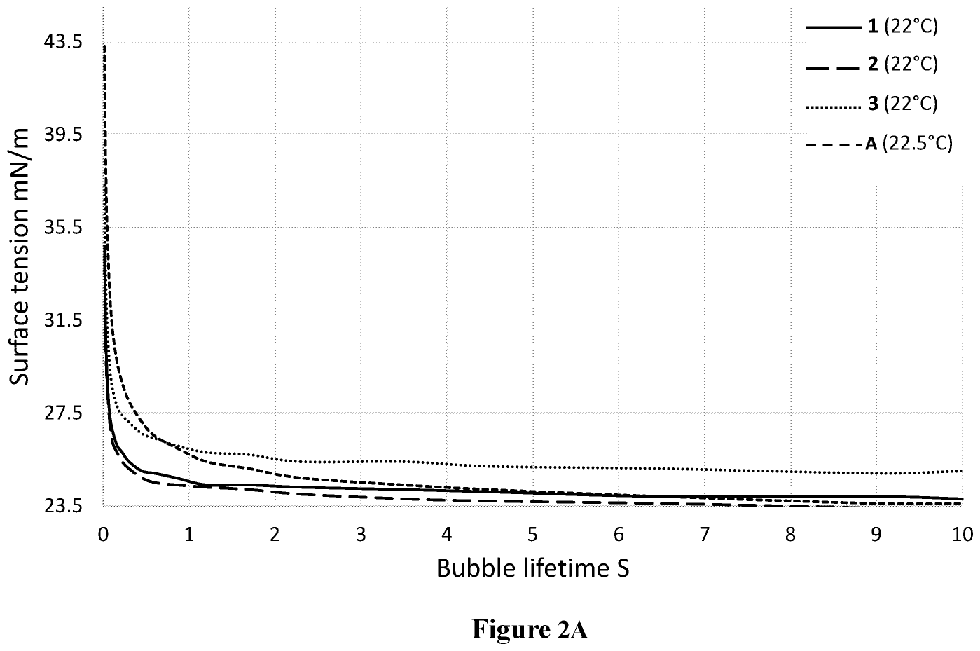

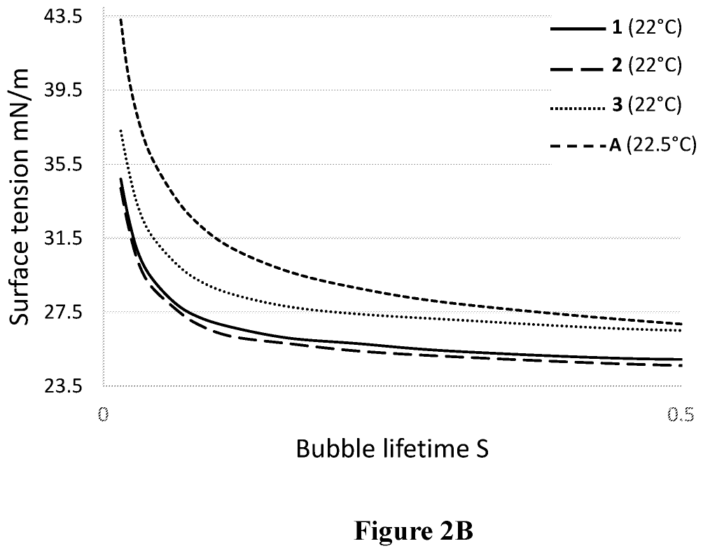

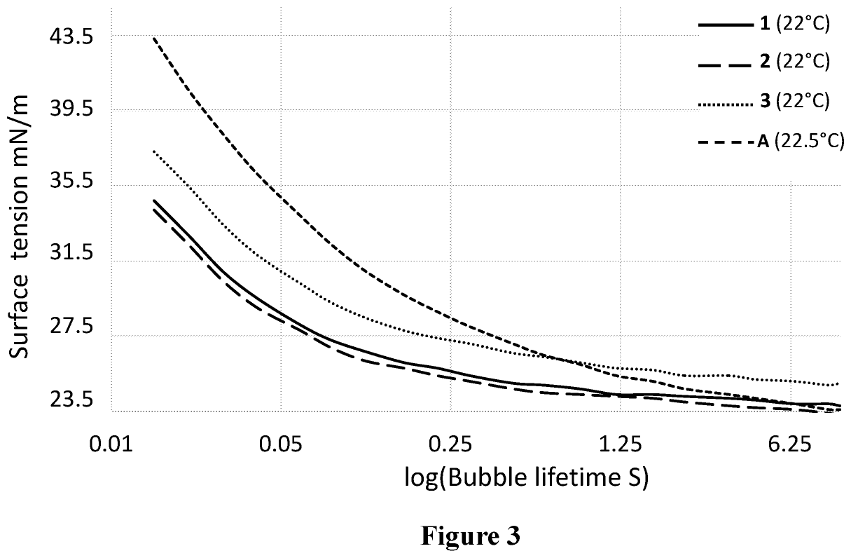

FIGS. 2A-2B display the dynamic surface tension profile (time scale) of the ink formulation A according to the invention compared to ink formulations 1, 2 and 3. FIG. 2B is an enlargement of FIG. 2A. FIG. 3 displays a log scale of the dynamic surface tension profile observed in FIGS. 2A-2B.

FIGS. 2A-2B and FIG. 3 illustrate that the ink formulation A has a DST of a higher value, at high frequency areas, compared to ink formulations 1-3.

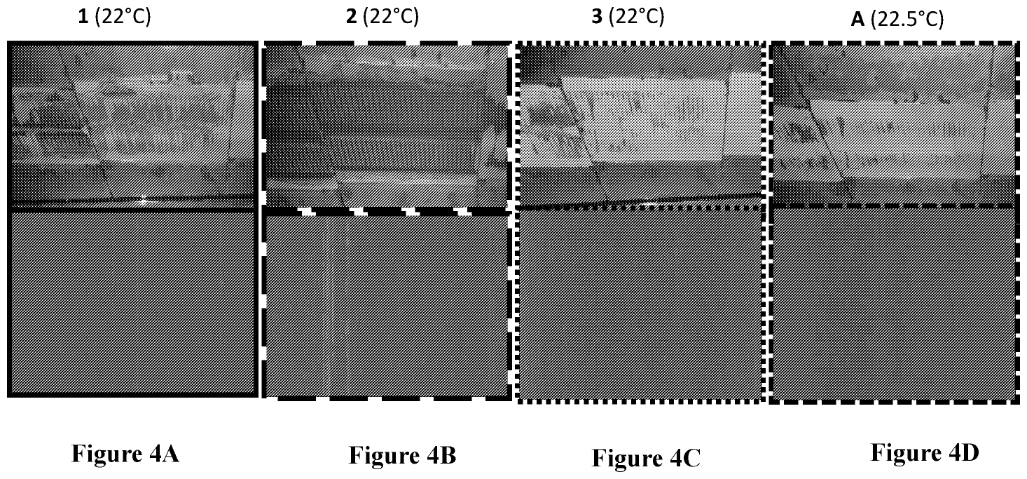

It is noted that both the ink formulations 1-3 not according to the invention and the ink formulation A according to the invention fulfilled the wetting requirements of the indirect printing process in which they were utilized, these requirements are reflected in the SST of these formulations, the value of which is detailed in Table 3 above. However, when utilizing the ink formulations 1-3 in the indirect printing process of the invention, extensive ink sweating at the print head nozzles was observed. The ink sweating was significantly reduced when the ink formulation A according to the invention was utilized. This is clearly observed in FIGS. 4A-4D.

FIGS. 4A-4D display images of nozzle plates (upper panel) and images of the resulted printed substrate (lower panel) when used with the ink formulations 1-3 and the ink formulation A, respectively. FIGS. 4A-4C clearly illustrate the sweating phenomena observed with the ink formulations which are not according to the invention i.e., formulations 1-3. The sweating was significantly reduced with formulation A of the invention (FIG. 4D). The printing quality was directly affected by the sweating effect of the ink formulations. This is illustrated in the lower panel of FIGS. 4A-4D in which the ink formulations which are not in accordance with the present invention exhibited a printing image with many light-colored areas/stripes which are indicative of a missing ink i.e., missing nozzles from which the ink was poorly jetted.

It is noted that the ink formulation A of the present invention comprised the silicone surfactant BYK-3456 while the ink formulations 1-3 comprised the silicone surfactants Tego 240 and Tego 280. Without wishing to be bound by theory, the inventors of the present invention believe that BYK-3456 has a DST that is applicable to the present invention, being “lazier” compared to the Tego 240 and Tego 280 surfactants i.e., the BYK-3456 surfactant comes out to the surface of the ink drop more slowly, a characteristic which is advantageous inter-alia in terms of mitigating/prevention ink sweating at the print head nozzle of the printing system.

The spreading rate performance of the ink formulation according to the invention was also compared to ink formulations which are not in accordance with the present invention. The ink spreading rate is correlated with the ink contact angle.

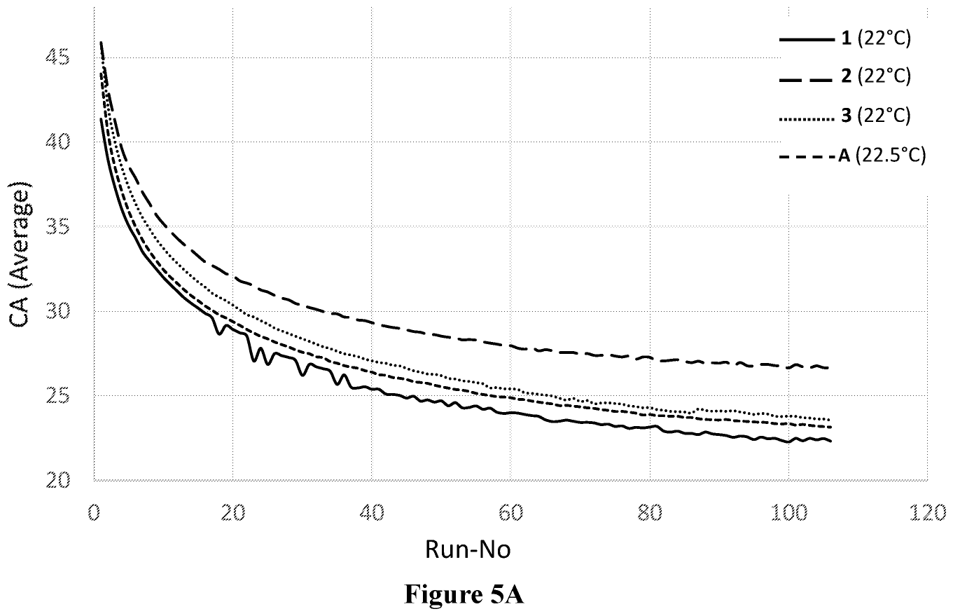

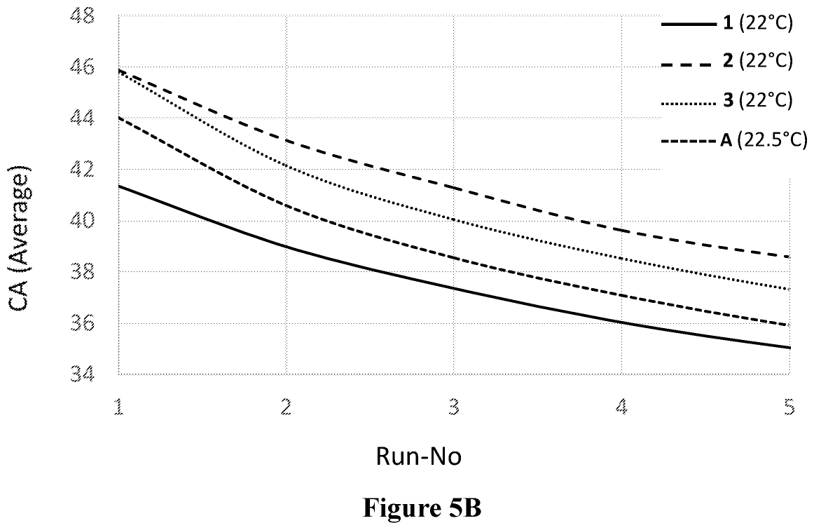

FIGS. 5A-5B display ink contact angle (CA) measurements as a function of run-no (i.e., time, measured every ˜3-7 sec) on hydrophobic ITM coated with a treatment formulation, at 80° C. FIG. 5B is an enlargement of FIG. 5A. The display in FIGS. 5A-5B is of ink formulations 1-3 and the ink formulation A. The figures illustrate good performance of all of the formulations in terms of ink contact angle, with reduction in CA as a function of the printing cycles, which is expected in the printing process. Thus, the ink formulations according to the presented invention illustrated spreading properties similar to ink formulations with low surface tension, but without the drawback of ink sweating at the print head nozzle associated with ink formulations having low surface tension.

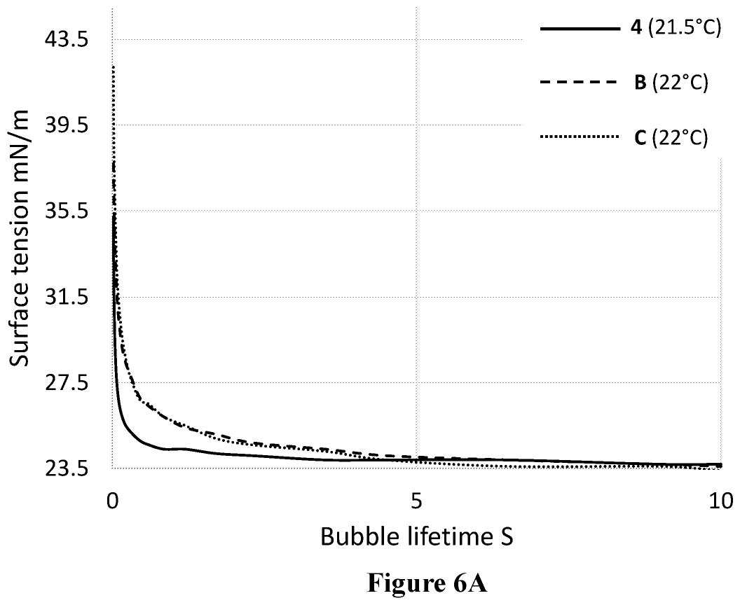

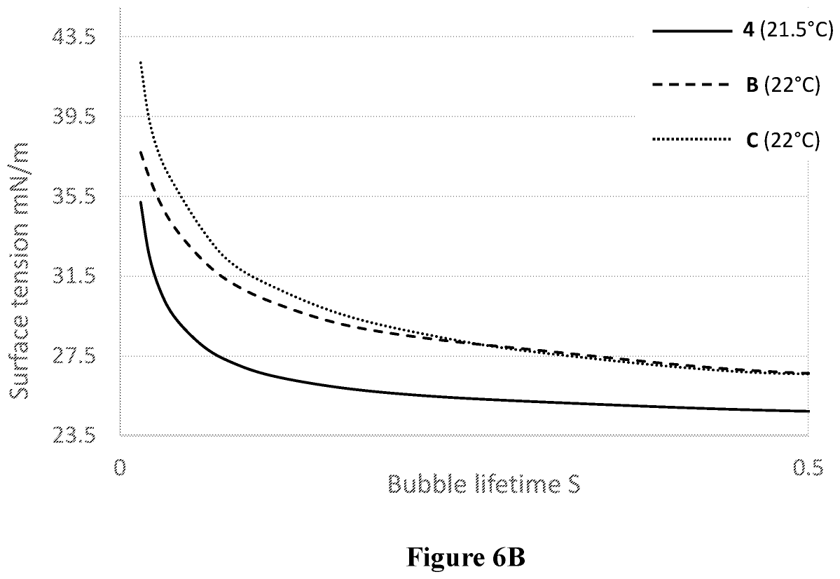

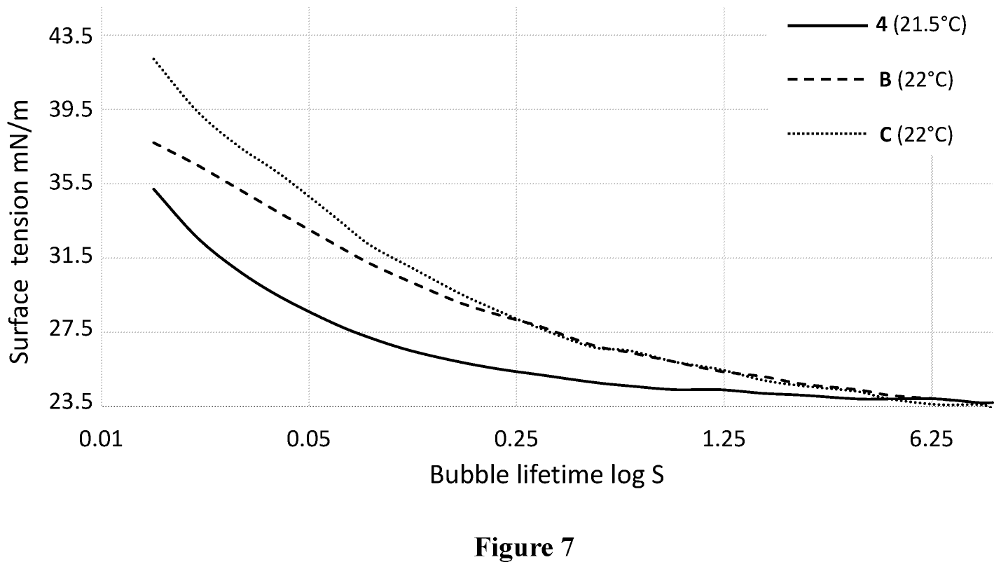

FIGS. 6A-6B display the dynamic surface tension profile (time scale) of the ink formulations B and C according to the invention compared to ink formulation 4 which is not in accordance with the present invention. FIG. 6B is an enlargement of FIG. 6A. FIG. 7 display a log scale of the dynamic surface tension profile observed in FIGS. 6A-6B.

FIGS. 6A-6B and FIG. 7 illustrate that the ink formulations B and C have a DST of a higher value, at high frequency areas, compared to ink formulation 4.

It is noted that the ink formulation B of the present invention comprised a mixture of the silicone surfactant BYK-3456 with the non-silicone surfactant Surfynol PSA 336. The ink formulation C of the present invention comprised the silicone surfactant BYK-3456. On the other hand, the ink formulation 4 which is not in accordance with the present invention comprised the silicone surfactants Tego 240 and Tego 270. Without wishing to be bound by theory, the inventors of the present invention believe that BYK-3456 as well as BYK-3456 in combination with Surfynol PSA 336 have a DST that is applicable to the present invention, being “lazier” compared to the Tego 240 and Tego 270 surfactants i.e., the surfactants of the present invention come out to the surface of the ink drop more slowly.

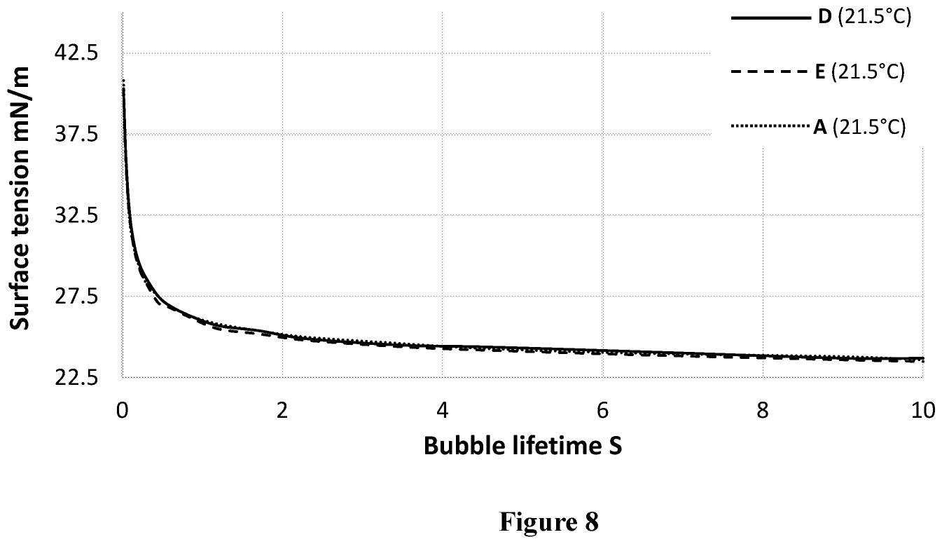

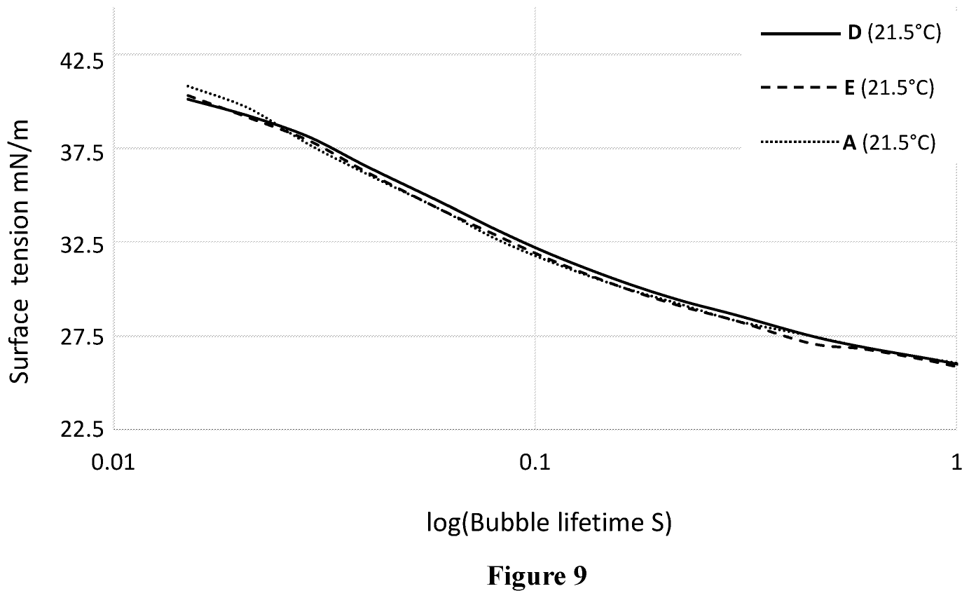

FIG. 8 display the dynamic surface tension profile (time scale) of the ink formulations A, D and E (having different viscosity, the latter was tuned by the co-solvent polyethylene glycol, to fulfill jet requirements). FIG. 9 display the dynamic surface tension profile (log scale) of these ink formulations. It is seen from FIG. 8 and FIG. 9 that the dynamic surface tension profile of ink formulations D and E is very similar to that of ink formulation A, the latter was illustrated in FIGS. 2A-2B and FIG. 3 as detailed above.

### Illustrative Embodiments

The following embodiments are illustrative and not intended to limit the claimed subject matter. Further, the embodiments detailed herein above in connection with other aspects of the invention are considered relevant also to embodiments detailed herein below mutatis mutandis.

EMBODIMENT 1 A water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (RT) with the bubble pressure method utilizing the Sita bubble pressure tensiometer—Model Sita online (Pro-line T15); and
wherein said at least one surfactant is selected to obtain said dynamic surface tension and said static surface tension.

EMBODIMENT 2 The water-based inkjet ink formulation of EMBODIMENT 1, wherein the static surface tension of the ink formulations is further determined with the standard liquid tensiometer, Kruss force tensiometer (K20 model), at a frequency of 5 Hz, at RT, said static surface tension being between about 23.8 to about 24.5 mN/m.

EMBODIMENT 3 The water-based inkjet ink formulation of EMBODIMENT 1 or 2, wherein said at least one surfactant is a surfactant of a first type and/or a surfactant of a second type.

EMBODIMENT 4 The water-based inkjet ink formulation of EMBODIMENT 3, wherein said surfactant of a first type is a silicone surfactant.

EMBODIMENT 5 The water-based inkjet ink formulation of EMBODIMENT 4, wherein said silicone surfactant is selected from the group consisting of polyether-modified polydimethylsiloxane, polyether-modified siloxane, siloxane-based gemini surfactant and any combination thereof.

EMBODIMENT 6 The water-based inkjet ink formulation of EMBODIMENT 5, wherein said siloxane-based gemini surfactant is Tego 4100.

EMBODIMENT 7 The water-based inkjet ink formulation of EMBODIMENT 5, wherein said polyether-modified siloxane surfactant is selected from the group consisting of Byk 349, BYK 348 BYK-3455, and any combination thereof.

EMBODIMENT 8 The water-based inkjet ink formulation of EMBODIMENT 5, wherein said polyether-modified polydimethylsiloxane surfactant is BYK-3456.

EMBODIMENT 9 The water-based inkjet ink formulation of EMBODIMENT 5, wherein said silicone surfactant is a polyether-modified polydimethylsiloxane having at least about 4 polyether-modified repeating units.

EMBODIMENT 10 The water-based inkjet ink formulation of EMBODIMENT 5, wherein said silicone surfactant is a polyether-modified siloxane having at least about 4 polyether-modified repeating units.

EMBODIMENT 11 The water-based inkjet ink formulation of EMBODIMENT 4, wherein said silicone surfactant is selected from the group consisting of Tego 4100, Byk 349, BYK 348, BYK-3456, BYK-3455 and any combination thereof.

EMBODIMENT 12 The water-based inkjet ink formulation of EMBODIMENT 3, wherein said surfactant of a second type is a non-silicone surfactant.

EMBODIMENT 13 The water-based inkjet ink formulation of EMBODIMENT 12, wherein said non-silicone surfactant is a blend of ethoxylated acetylene diol and dioctyl sodium sulfosuccinate in solvent.

EMBODIMENT 14 The water-based inkjet ink formulation of EMBODIMENT 13, wherein said non-silicone surfactant is Surfynol PSA 336.

EMBODIMENT 15 The water-based inkjet ink formulation of any one of the preceding EMBODIMENTS wherein said at least one surfactant is a surfactant of a first type, being a silicone surfactant, and wherein said ink formulation optionally further comprises at least one surfactant of a second type, being a non-silicone surfactant.

EMBODIMENT 16 The water-based inkjet ink formulation of any one of the preceding EMBODIMENTS wherein said at least one surfactant is a surfactant of a second type, being a non-silicone surfactant, and wherein said ink formulation optionally further comprises at least one surfactant of a first type, being a silicone surfactant.

EMBODIMENT 17 The water-based inkjet ink formulation of any one of the preceding EMBODIMENTS wherein said at least one surfactant is a surfactant of a first type, being a silicone surfactant, selected from the group consisting of polyether-modified polydimethylsiloxane, polyether-modified siloxane, siloxane-based gemini surfactant and any combination thereof, wherein the ink formulation optionally further comprises at least one surfactant of a second type being a blend of ethoxylated acetylene diol and dioctyl sodium sulfosuccinate in solvent.

EMBODIMENT 18 The water-based inkjet ink formulation of any one of the preceding EMBODIMENTS wherein said at least one surfactant is a surfactant of a first type, being a silicone surfactant, selected from the group consisting of Tego 4100, Byk 349, BYK 348, BYK-3456, BYK-3455 and any combination thereof, wherein the ink formulation optionally further comprises at least one surfactant of a second type being Surfynol PSA.

EMBODIMENT 19 The water-based inkjet ink formulation of any one of the preceding EMBODIMENTS wherein said at least one surfactant is a surfactant of a first type, being BYK-3456 and wherein the ink formulation optionally further comprises at least one surfactant of a second type being Surfynol PSA.

EMBODIMENT 20 The water-based inkjet ink formulation of any one of the preceding EMBODIMENTS wherein said at least one surfactant is present in the water-based inkjet ink formulation at a concentration of between about 0.1 w/w % to about 3.0 w/w %.

EMBODIMENT 21 The water-based inkjet ink formulation of any one of the preceding EMBODIMENTS wherein said at least one surfactant is a surfactant of a first type being present in the water-based inkjet ink formulation at a concentration of between about 0.1 w/w % to about 3.0 w/w.

EMBODIMENT 22 The water-based inkjet ink formulation of any one of the preceding EMBODIMENTS wherein said at least one surfactant is a surfactant of a second type being present in the water-based inkjet ink formulation at a concentration of between about 0.1 w/w % to about 0.5 w/w %.

EMBODIMENT 23 The water-based inkjet ink formulation of any one of the preceding EMBODIMENTS wherein said at least one surfactant is a surfactant of a first type and a surfactant of a second type, wherein said surfactant of a first type being present in the water-based inkjet ink formulation at a concentration of between about 0.1 w/w % to about 3.0 w/w and wherein said surfactant of a second type optionally being present in the water-based inkjet ink at a concentration of between about 0.0 w/w % to about 0.5 w/w %.

EMBODIMENT 24 The water-based inkjet ink formulation of any one of the preceding EMBODIMENTS wherein the water constitutes at least about 30 w/w % of the formulation, at times at least about 40 w/w %, event at times at least about 50 w/w % or more.

EMBODIMENT 25 The water-based inkjet ink formulation of any one of the preceding EMBODIMENTS wherein said formulation further comprises at least one co-solvent e.g., humectant.

EMBODIMENT 26 The water-based inkjet ink formulation of any one of the preceding EMBODIMENTS wherein said formulation further comprises at least one plasticizer.

EMBODIMENT 27 The water-based inkjet ink formulation of any one of the preceding EMBODIMENTS wherein said formulation further comprises at least one dispersant.

EMBODIMENT 28 The water-based inkjet ink formulation of any one of the preceding EMBODIMENTS wherein said formulation further comprises at least one anti-corrosion agent.

EMBODIMENT 29 The water-based inkjet ink formulation of any one of the preceding EMBODIMENTS wherein said formulation further comprises at least one antibacterial agent.

EMBODIMENT 30 The water-based inkjet ink formulation of any one of the preceding EMBODIMENTS wherein said formulation further comprises at least one wax material.

EMBODIMENT 31 The water-based inkjet ink formulation of any one of the preceding EMBODIMENTS wherein said formulation further comprises one or more of at least one anti gelation agent, at least one pH controlling agent and at least one antifoaming agent.

EMBODIMENT 32 The water-based inkjet ink formulation of any one of the preceding EMBODIMENTS wherein said formulation further comprises at least one binder (e.g., organic polymeric resin).

EMBODIMENT 33 A method for one or more of improving a printing process and improving the quality of a resulted printed image, the method comprises utilizing (e.g., in the printing process) a water-based inkjet ink formulation comprising:
(a) a solvent containing water;
(b) at least one coloring agent; and
(c) at least one surfactant;
   wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
   wherein said at least one surfactant is selected to obtain said dynamic surface tension and said static surface tension, to thereby improve one or more of the printing process and the quality of the resulted printed image.

EMBODIMENT 34 The method of EMBODIMENT 33, wherein said water-based inkjet ink formulation is the formulation of any one of EMBODIMENTS 1 to 32.

EMBODIMENT 35 A water-based inkjet ink formulation of any one of EMBODIMENTS 1 to 32, for use in a printing process, wherein said process is a direct or an indirect process.

EMBODIMENT 36 A printing method utilizing the water-based inkjet ink formulation of any one of EMBODIMENTS 1 to 32.

EMBODIMENT 37 A printing system comprising the water-based inkjet ink formulation of any one of EMBODIMENTS 1 to 32.

EMBODIMENT 38 A printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation of any one of EMBODIMENTS 1 to 32.

EMBODIMENT 39 A printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation of any one of EMBODIMENTS 1 to 32; and
a transfer station for transferring said ink images from the intermediate transfer member to a printing substrate.

EMBODIMENT 40 The system of EMBODIMENT 39, further comprising a drying station configured to substantially dry the ink images formed on the intermediate transfer member, and wherein said transfer station is configured to transfer the substantially dry ink image from the intermediate transfer member to a printing substrate.

EMBODIMENT 41 A method of printing on a substrate, the method comprises ink-jetting an ink formulation onto a printing substrate by utilizing one or more print bars, each of which comprises one or more print heads, to thereby form ink images on said substrate, wherein the ink formulation is the water-based inkjet ink formulation of any one of EMBODIMENTS 1 to 32.

EMBODIMENT 42 A printing method comprising:
providing an intermediate transfer member comprising a release layer surface;
ink-jetting an ink formulation onto said release layer surface by utilizing one or more print bars, each of which comprises one or more print heads, to thereby form ink images on said release layer surface; and
transferring said ink images from the intermediate transfer member to a printing substrate;
wherein said ink formulation is the water-based inkjet ink formulation of any one of EMBODIMENTS 1 to 32.

EMBODIMENT 43 The method of EMBODIMENT 42, further comprising substantially drying the ink images formed on the intermediate transfer member and transferring the substantially dry ink images from the intermediate transfer member to a printing substrate.

1. A water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (RT) with the bubble pressure method utilizing the Sita bubble pressure tensiometer—Model Sita online (Pro-line T15); and
wherein said at least one surfactant is selected to obtain said dynamic surface tension and said static surface tension.

2. The water-based inkjet ink formulation of claim 1, wherein the static surface tension of the ink formulations is further determined with the standard liquid tensiometer, Kruss force tensiometer (K20 model), at a frequency of 5 Hz, at RT, said static surface tension being between about 23.8 to about 24.5 mN/m.

3. The water-based inkjet ink formulation of claim 1 or 2, wherein said at least one surfactant is a surfactant of a first type and/or a surfactant of a second type.

4. The water-based inkjet ink formulation of claim 3, wherein said surfactant of a first type is a silicone surfactant.

5. The water-based inkjet ink formulation of claim 4, wherein said silicone surfactant is selected from the group consisting of polyether-modified polydimethylsiloxane, polyether-modified siloxane, siloxane-based gemini surfactant and any combination thereof.

6. The water-based inkjet ink formulation of claim 5, wherein said siloxane-based gemini surfactant is Tego 4100.

7. The water-based inkjet ink formulation of claim 5, wherein said polyether-modified siloxane surfactant is selected from the group consisting of Byk 349, BYK 348 BYK-3455, and any combination thereof.

8. The water-based inkjet ink formulation of claim 5, wherein said polyether-modified polydimethylsiloxane surfactant is BYK-3456.

9. The water-based inkjet ink formulation of claim 5, wherein said silicone surfactant is a polyether-modified polydimethylsiloxane having at least about 4 polyether-modified repeating units.

10. The water-based inkjet ink formulation of claim 5, wherein said silicone surfactant is a polyether-modified siloxane having at least about 4 polyether-modified repeating units.

11. The water-based inkjet ink formulation of claim 4, wherein said silicone surfactant is selected from the group consisting of Tego 4100, Byk 349, BYK 348, BYK-3456, BYK-3455 and any combination thereof.

12. The water-based inkjet ink formulation of claim 3, wherein said surfactant of a second type is a non-silicone surfactant.

13. The water-based inkjet ink formulation of claim 12, wherein said non-silicone surfactant is a blend of ethoxylated acetylene diol and dioctyl sodium sulfosuccinate in solvent.

14. The water-based inkjet ink formulation of claim 13, wherein said non-silicone surfactant is Surfynol PSA 336.

15. The water-based inkjet ink formulation of any one of the preceding claims wherein said at least one surfactant is a surfactant of a first type, being a silicone surfactant, and wherein said ink formulation optionally further comprises at least one surfactant of a second type, being a non-silicone surfactant.

16. The water-based inkjet ink formulation of any one of the preceding claims wherein said at least one surfactant is a surfactant of a second type, being a non-silicone surfactant, and wherein said ink formulation optionally further comprises at least one surfactant of a first type, being a silicone surfactant.

17. The water-based inkjet ink formulation of any one of the preceding claims wherein said at least one surfactant is a surfactant of a first type, being a silicone surfactant, selected from the group consisting of polyether-modified polydimethylsiloxane, polyether-modified siloxane, siloxane-based gemini surfactant and any combination thereof, wherein the ink formulation optionally further comprises at least one surfactant of a second type being a blend of ethoxylated acetylene diol and dioctyl sodium sulfosuccinate in solvent.

18. The water-based inkjet ink formulation of any one of the preceding claims wherein said at least one surfactant is a surfactant of a first type, being a silicone surfactant, selected from the group consisting of Tego 4100, Byk 349, BYK 348, BYK-3456, BYK-3455 and any combination thereof, wherein the ink formulation optionally further comprises at least one surfactant of a second type being Surfynol PSA.

19. The water-based inkjet ink formulation of any one of the preceding claims wherein said at least one surfactant is a surfactant of a first type, being BYK-3456 and wherein the ink formulation optionally further comprises at least one surfactant of a second type being Surfynol PSA.

20. The water-based inkjet ink formulation of any one of the preceding claims wherein said at least one surfactant is present in the water-based inkjet ink formulation at a concentration of between about 0.1 w/w % to about 3.0 w/w %.

21. The water-based inkjet ink formulation of any one of the preceding claims wherein said at least one surfactant is a surfactant of a first type being present in the water-based inkjet ink formulation at a concentration of between about 0.1 w/w % to about 3.0 w/w.

22. The water-based inkjet ink formulation of any one of the preceding claims wherein said at least one surfactant is a surfactant of a second type being present in the water-based inkjet ink formulation at a concentration of between about 0.1 w/w % to about 0.5 w/w %.

23. The water-based inkjet ink formulation of any one of the preceding claims wherein said at least one surfactant is a surfactant of a first type and a surfactant of a second type, wherein said surfactant of a first type being present in the water-based inkjet ink formulation at a concentration of between about 0.1 w/w % to about 3.0 w/w and wherein said surfactant of a second type optionally being present in the water-based inkjet ink at a concentration of between about 0.0 w/w % to about 0.5 w/w %.

24. The water-based inkjet ink formulation of any one of the preceding claims wherein the water constitutes at least about 30 w/w % of the formulation, at times at least about 40 w/w %, event at times at least about 50 w/w % or more.

25. The water-based inkjet ink formulation of any one of the preceding claims wherein said formulation further comprises at least one co-solvent e.g., humectant.

26. The water-based inkjet ink formulation of any one of the preceding claims wherein said formulation further comprises at least one plasticizer.

27. The water-based inkjet ink formulation of any one of the preceding claims wherein said formulation further comprises at least one dispersant.

28. The water-based inkjet ink formulation of any one of the preceding claims wherein said formulation further comprises at least one anti-corrosion agent.

29. The water-based inkjet ink formulation of any one of the preceding claims wherein said formulation further comprises at least one antibacterial agent.

30. The water-based inkjet ink formulation of any one of the preceding claims wherein said formulation further comprises at least one wax material.

31. The water-based inkjet ink formulation of any one of the preceding claims wherein said formulation further comprises one or more of at least one anti gelation agent, at least one pH controlling agent and at least one antifoaming agent.

32. The water-based inkjet ink formulation of any one of the preceding claims wherein said formulation further comprises at least one binder (e.g., organic polymeric resin).

33. A method for one or more of improving a printing process and improving the quality of a resulted printed image, the method comprises utilizing (e.g., in the printing process) a water-based inkjet ink formulation comprising:
(a) a solvent containing water;
(b) at least one coloring agent; and
(c) at least one surfactant;
wherein said ink formulation has a dynamic surface tension of between about 37 to about 50 mN/m (measured at a bubble life-time of about 0.015 sec) and a static surface tension of between about 23.0 to about 25.5 mN/m (measured at a bubble life-time of about 10 sec), wherein both of said dynamic surface tension and said static surface tension are determined at room temperature (e.g., about 22° C.) with the bubble pressure method utilizing the Sita bubble pressure tensiometer—Model Sita online (Pro-line T15); and
wherein said at least one surfactant is selected to obtain said dynamic surface tension and said static surface tension, to thereby improve one or more of the printing process and the quality of the resulted printed image.

34. The method of claim 33, wherein said water-based inkjet ink formulation is the formulation of any one of claims 1 to 32.

35. A water-based inkjet ink formulation of any one of claims 1 to 32, for use in a printing process, wherein said process is a direct or an indirect process.

36. A printing method utilizing the water-based inkjet ink formulation of any one of claims 1 to 32.

37. A printing system comprising the water-based inkjet ink formulation of any one of claims 1 to 32.

38. A printing system comprising an image forming station comprising one or more print bars, each of which is configured to hold an ink formulation and comprises one or more print heads, each of said one or more print heads is configured to jet said ink formulation onto a printing substrate to form ink images on said substrate, wherein at least one of said one or more print bars is configured to hold the water-based inkjet ink formulation of any one of claims 1 to 32.

39. A printing system comprising:
an intermediate transfer member comprising a release layer surface;
an image forming station comprising one or more print bars, each of which is configured to hold an ink formulation and comprises one or more print heads, each of said one or more print heads is configured to jet said ink formulation onto said release layer surface to form ink images thereon, wherein at least one of said one or more print bars is configured to hold the water-based inkjet ink formulation of any one of claims 1 to 32; and
a transfer station for transferring said ink images from the intermediate transfer member to a printing substrate.

40. The system of claim 39, further comprising a drying station configured to substantially dry the ink images formed on the intermediate transfer member, and wherein said transfer station is configured to transfer the substantially dry ink image from the intermediate transfer member to a printing substrate.

41. A method of printing on a substrate, the method comprises ink-jetting an ink formulation onto a printing substrate by utilizing one or more print bars, each of which comprises one or more print heads, to thereby form ink images on said substrate, wherein the ink formulation is the water-based inkjet ink formulation of any one of claims 1 to 32.

42. A printing method comprising:
providing an intermediate transfer member comprising a release layer surface;
ink-jetting an ink formulation onto said release layer surface by utilizing one or more print bars, each of which comprises one or more print heads, to thereby form ink images on said release layer surface; and
transferring said ink images from the intermediate transfer member to a printing substrate;
wherein said ink formulation is the water-based inkjet ink formulation of any one of claims 1 to 32.

43. The method of claim 42, further comprising substantially drying the ink images formed on the intermediate transfer member and transferring the substantially dry ink images from the intermediate transfer member to a printing substrate.
